(19) United States
(12) Patent Application Publication
(10) Pub. No.: US 2024/0337817 A1
(43) Pub. Date: Oct. 10, 2024

(54) PHOTOGRAPHING LENS ASSEMBLY, IMAGING APPARATUS AND ELECTRONIC DEVICE

(71) Applicant: LARGAN PRECISION CO., LTD., Taichung (TW)

(72) Inventors: CHENG-YU TSAI, Taichung (TW); GUAN-BO LIN, Taichung (TW)

(21) Appl. No.: 18/222,553

(22) Filed: Jul. 17, 2023

(30) Foreign Application Priority Data
Apr. 7, 2023 (TW) 112113029

(51) Int. Cl. G02B 13/00

(52) U.S. Cl. CPC G02B 13/004; G02B 13/008

(57) ABSTRACT

A photographing lens assembly in order from an object side to an image side comprises a first lens element, a second lens element, a third lens element and a fourth lens element. Each of the four lens elements has an object-side surface facing the object side and an image-side surface facing the image side. The first lens element has negative refractive power. The image-side surface of the fourth lens element is concave in a paraxial region thereof. An axial distance between the object-side surface of the first lens element and the image-side surface of the fourth lens element is TD, an axial distance between the image-side surface of the fourth lens element and an image surface at d-line reference wavelength is BLd, an Abbe number of the fourth lens element at d-line reference wavelength is V4d, and 1.0<TD/BLd<2.4 and 10.0<V4d<24.0 are satisfied.

### RELATED APPLICATIONS

This application claims priority to Taiwan Application Serial Number 112113029, filed on Apr. 7, 2023, which is incorporated by reference herein in its entirety.

### BACKGROUND

### Technical Field

The present disclosure relates to a photographing lens assembly and an imaging apparatus, and more particularly, to a photographing lens assembly and an imaging apparatus applicable to electronic devices.

### Description of Related Art

With the advancement in semiconductor process technology, performances of image sensors have been improved, and pixels have been reduced to even smaller sizes. Therefore, optical lens systems with high image quality have become an indispensable part of modern electronic devices. Meanwhile, the rapid development of science and technology and the popularity of high-performance microprocessors and microdisplays have led to the rapid improvement of technologies related to smart head-mounted displays in recent years. With the rise of artificial intelligence, the application range of electronic devices equipped with optical lens systems have become wider: in particular, the demand for computer vision in electronic devices has grown significantly, and the requirements for optical lens systems have become more diverse.

Today's head-mounted displays are not only significantly lighter than in the past, but have also equipped with a variety of smart functions; in the areas of virtual reality (VR), augmented reality (AR) and mixed reality (MR), for example, the use of smart head-mounted displays is growing rapidly. Specifically, most smart head-mounted displays use general imaging camera modules for dynamic tracking and positioning of user movements and use eye tracking cameras for eye gaze positioning, so that the load of real-time image processing can be reduced, and users can be provided with clear and low-latency images to experience highly immersive visual effects.

### SUMMARY

The present disclosure provides an optical lens system that can be used for the wavelength range of infrared light, has high image quality while remaining miniaturized, and is applicable for dynamic eye gaze tracking and positioning.

According to one aspect of the present disclosure, a photographing lens assembly comprises four lens elements. The four lens elements in order from an object side to an image side along an optical path are a first lens element, a second lens element, a third lens element, and a fourth lens element. Each of the first through fourth lens elements has an object-side surface facing the object side and an image-side surface facing the image side.

Preferably, the first lens element has negative refractive power, the image-side surface of the first lens element is concave in a paraxial region thereof, the image-side surface of the third lens element is convex in a paraxial region thereof, the image-side surface of the fourth lens element is concave in a paraxial region thereof, and the fourth lens element has at least one inflection point.

An axial distance between the object-side surface of the first lens element and the image-side surface of the fourth lens element is TD, an axial distance between the image-side surface of the fourth lens elements and an image surface at d-line reference wavelength is BLd, an Abbe number of the fourth lens element at d-line reference wavelength is V4d, a focal length of the first lens element at d-line reference wavelength is f1d, a curvature radius of the image-side surface of the first lens element is R2, a curvature radius of the image-side surface of the second lens element is R4, a central thickness of the first lens element along the optical path is CT1, a central thickness of the third lens element along the optical path is CT3, a central thickness of the fourth lens element along the optical path is CT4, and the following conditions are satisfied:

$$1. < TD / BLd < 2.4 ;$$

$$10. < V 4 d < 24. ;$$

$$- 2.6 < f 1 d / R 2 < 0 ;$$

$$0.3 < \vert f 1 d / R 4 \vert < 5.4 ;$$

$$and$$

$$0.82 < ( CT 1 + CT 4 ) / CT 3 < 2.0 .$$

According to one aspect of the present disclosure, an imaging apparatus comprises the aforementioned photographing lens assembly and an image sensor.

According to another aspect of the present disclosure, an electronic device comprises the aforementioned imaging apparatuses.

According to one aspect of the present disclosure, a photographing lens assembly comprises four lens elements. The four lens elements in order from an object side to an image side along an optical path are a first lens element, a second lens element, a third lens element, and a fourth lens element. Each of the first through fourth lens elements has an object-side surface facing the object side and an image-side surface facing the image side.

The photographing lens assembly further comprises an aperture stop, and preferably, the first lens element has negative refractive power, and the image-side surface of the fourth lens element is concave in a paraxial region thereof. Preferably, an axial distance between the object-side surface of the first lens element and the image-side surface of the fourth lens element is TD, an axial distance between the image-side surface of the fourth lens elements and an image surface at d-line reference wavelength is BLd, an Abbe number of the fourth lens element at d-line reference wavelength is V4d, an f-number of the photographing lens assembly is Fno, a sum of the central thicknesses of the first lens element, the second lens element, the third lens element, and the fourth lens element along the optical path is ΣCT, a sum of axial distances between every two adjacent lens elements of the photographing lens assembly is ΣAT, a curvature radius of the object-side surface of the first lens element is R1, a curvature radius of the image-side surface of the first lens element is R2, an axial distance between the object-side surface of the first lens element and an image surface at d-line reference wavelength is TLd, an axial distance between the aperture stop and the image-side surface of the fourth lens element is SD, and the following conditions are satisfied:

$$1. < TD / BLd < 2.4 ;$$

$$10. < V 4 d < 24. ;$$

$$1.5 < Fno < 3. ;$$

$$2.8 < \sum CT / \sum AT < 5.5 ;$$

$$- 1.5 < ( R 1 + R 2 ) / ( R 1 - R 2 ) < 1.4 ;$$

$$and$$

$$2.55 < TLd / SD < 4.5 .$$

According to one aspect of the present disclosure, a photographing lens assembly comprises four lens elements. The four lens elements in order from an object side to an image side along an optical path are a first lens element, a second lens element, a third lens element, and a fourth lens element. Each of the first through fourth lens elements has an object-side surface facing the object side and an image-side surface facing the image side.

Preferably, the first lens element has negative refractive power, the image-side surface of the first lens element is concave in a paraxial region thereof, the second lens element has positive refractive power, the image-side surface of the fourth lens element is concave in a paraxial region thereof, and the fourth lens element has at least one inflection point.

An axial distance between the object-side surface of the first lens element and the image-side surface of the fourth lens element is TD, an axial distance between the image-side surface of the fourth lens elements and an image surface at d-line reference wavelength is BLd, an Abbe number of the fourth lens element at d-line reference wavelength is V4d, a focal length of the first lens element at d-line reference wavelength is f1d, a curvature radius of the image-side surface of the first lens element is R2, an axial distance between the first lens element and the second lens element is T12, a central thickness of the first lens element along the optical path is CT1, a curvature radius of the object-side surface of the second lens element is R3, a curvature radius of the image-side surface of the second lens element is R4, and the following conditions are satisfied:

$$1. < TD / BLd < 2.4 ;$$

$$10. < V 4 d < 24. ;$$

$$- 2.8 < f 1 d / R 2 < - 0.1 ;$$

$$0.2 < T 12 / CT 1 < 1.7 ;$$

$$and$$

$$- 0.4 \; 8 < ( R 3 R 4 ) / ( R 3 + R 4 ) < 160 .$$

### BRIEF DESCRIPTION OF THE DRAWINGS

FIG. 1A is a schematic view of an imaging apparatus according to the 1st embodiment of the present disclosure;

FIG. 1B shows longitudinal spherical aberration curves, astigmatic field curves and a distortion curve of the imaging apparatus according to the 1st embodiment;

FIG. 2A is a schematic view of an imaging apparatus according to the 2nd embodiment of the present disclosure;

FIG. 2B shows longitudinal spherical aberration curves, astigmatic field curves and a distortion curve of the imaging apparatus according to the 2nd embodiment;

FIG. 3A is a schematic view of an imaging apparatus according to the 3rd embodiment of the present disclosure;

FIG. 3B shows longitudinal spherical aberration curves, astigmatic field curves and a distortion curve of the imaging apparatus according to the 3rd embodiment;

FIG. 4A is a schematic view of an imaging apparatus according to the 4th embodiment of the present disclosure;

FIG. 4B shows longitudinal spherical aberration curves, astigmatic field curves and a distortion curve of the imaging apparatus according to the 4th embodiment;

FIG. 5A is a schematic view of an imaging apparatus according to the 5th embodiment of the present disclosure;

FIG. 5B shows longitudinal spherical aberration curves, astigmatic field curves and a distortion curve of the imaging apparatus according to the 5th embodiment:

FIG. 6A is a schematic view of an imaging apparatus according to the 6th embodiment of the present disclosure:

FIG. 6B shows longitudinal spherical aberration curves, astigmatic field curves and a distortion curve of the imaging apparatus according to the 6th embodiment;

FIG. 7A is a schematic view of an imaging apparatus according to the 7th embodiment of the present disclosure:

FIG. 7B shows longitudinal spherical aberration curves, astigmatic field curves and a distortion curve of the imaging apparatus according to the 7th embodiment; FIG. 8A is a schematic view of an imaging apparatus according to the 8th embodiment of the present disclosure:

FIG. 8B shows longitudinal spherical aberration curves, astigmatic field curves and a distortion curve of the imaging apparatus according to the 8th embodiment; FIG. 9A is a schematic view of an imaging apparatus according to the 9th embodiment of the present disclosure:

FIG. 9B shows longitudinal spherical aberration curves, astigmatic field curves and a distortion curve of the imaging apparatus according to the 9th embodiment:

FIG. 10 is a schematic view illustrating the parameters SAG1R1, Y1R1, SAG1R2 and Y4R2 of the photographing lens assembly, with the 1st embodiment of the present disclosure as an example:

FIG. 11 is a schematic view illustrating the inflection points and the critical points of the photographing lens assembly, with the 1st embodiment of the present disclosure as an example:

FIG. 12 is a 3-dimensional schematic view of an imaging apparatus according to the 10th embodiment of the present disclosure:

FIG. 13 is a rear view of an electronic device according to the 11th embodiment of the present disclosure:

FIG. 14 is a rear view of an electronic device according to the 12th embodiment of the present disclosure;

FIG. 15A is a front view of an electronic device according to the 13th embodiment of the present disclosure; and

FIG. 15B is a rear view of the electronic device according to the 13th embodiment of the present disclosure.

### DETAILED DESCRIPTION

The present disclosure provides a photographing lens assembly comprising four lens elements. The four lens elements in order from an object side to an image side along an optical path are a first lens element, a second lens element, a third lens element, and a fourth lens element. Each of the first through fourth lens elements has an object-side surface facing the object side and an image-side surface facing the image side.

The first lens element has negative refractive power, which is favorable for increasing the field of view and the size of the image.

The image-side surface of the first lens element is concave in a paraxial region thereof, so that the refractive power of the first lens element can be adjusted.

Both the object-side surface and the image-side surface of the first lens element are aspheric, so that the shape of the first element can be designed with more flexibility to facilitate the manufacturing of the lens elements and the correction of aberrations.

The second lens element has positive refractive power, so that light rays can converge more favorably to reduce the size of the photographing lens assembly.

The image-side surface of the second lens element is convex in a paraxial region thereof, so that the shapes and refractive power of the second lens element can be adjusted, which is favorable for reducing the size of the photographing lens assembly and correcting aberrations.

The object-side surface of the third lens element is concave in a paraxial region thereof, so that spherical aberrations and comatic aberrations of the optical system can be well balanced.

The image-side surface of the third lens element is convex in a paraxial region thereof, so that the light traveling direction can be adjusted to favorably increase the image surface.

The image-side surface of the fourth lens element is concave in a paraxial region thereof, so that the back focal length of the optical system can be balanced and off-axis aberrations can be corrected.

The first through fourth lens elements have at least one inflection point, which can help correct and compensate for aberrations at the image periphery.

The fourth lens element has at least one inflection point, so that the surface shapes of the fourth lens element can be adjusted to correct off-axis aberrations.

The object-side surface of the fourth lens element has at least one inflection point, which can help enhancing the aberration correction capability at the image periphery on the object side of the fourth lens element.

An f-number of the photographing lens assembly is Fno. When the following condition is satisfied: 1.5<Fno<3.0, a balance between illuminance and depth of field can be achieved, and the amount of incoming light can be increased to improve image quality. Moreover, the following condition can be satisfied: 1.8<Fno<2.8. Moreover, the following condition can be satisfied: 1.9<Fno<2.6.

A field of view of the photographing lens assembly at d-line reference wavelength is FOVd. When the following condition is satisfied: 70.0<FOVd<110.0, the optical lens system can have a sufficient imaging range to meet the field of view requirements for application devices. Moreover, the following condition can be satisfied: 75.0<FOVd<100.0. Moreover, the following condition can be satisfied: 78.0<FOVd<95.0.

An axial distance between the object-side surface of the first lens element and an image surface at d-line reference wavelength is TLd, and an entrance pupil diameter of the photographing lens assembly at d-line reference wavelength is EPDd. When the following condition is satisfied: 5.0<TLd/EPDd<9.0, the total track length of the photographing lens assembly can be reduced, and the amount of incoming light can be increased to enhance the brightness of the image surface. Moreover, the following condition can be satisfied: 5.5<TLd/EPDd<8.5.

The axial distance between the object-side surface of the first lens element and an image surface at d-line reference wavelength is TLd, and an axial distance between the aperture stop and the image-side surface of the fourth lens element is SD. When the following condition is satisfied: 2.55<TLd/SD<4.5, the angle of view of the photographing lens assembly can be better adjusted, which is favorable for the use in various application fields. Moreover, the following condition can be satisfied: 2.8<TLd/SD<4.0.

An axial distance between the object-side surface of the first lens element and the image-side surface of the fourth lens element is TD, and an axial distance between the image-side surface of the fourth lens elements and an image surface at d-line reference wavelength is BLd. When the following condition is satisfied: 1.0<TD/BLd<2.4, a balance between space arrangement of the lens elements and the back focal length of the optical system can be obtained, so that miniaturization of the photographing lens assembly can be achieved. Moreover, the following condition can be satisfied: 1.4<TD/BLd<2.2.

The axial distance between the image-side surface of the fourth lens elements and an image surface at d-line reference wavelength is BLd, and the axial distance between the aperture stop and the image-side surface of the fourth lens element is SD. When the following condition is satisfied: 0.7<BLd/SD<2.0, the back focal length of the optical system and the amount of incoming light can be effectively adjusted while maintaining good space utilization. Moreover, the following condition can be satisfied: 0.9<BLd/SD<1.5.

A focal length of the photographing lens assembly at d-line reference wavelength is fd, and the axial distance between the object-side surface of the first lens element and an image surface at d-line reference wavelength is TLd. When the following condition is satisfied: 0.25<fd/TLd<0.50, a balance between the field of view and the total track length can be obtained, so that a balance between the size of the photographing lens assembly and image quality can be achieved. Moreover, the following condition can be satisfied: 0.27<fd/TLd<0.40.

The focal length of the photographing lens assembly at d-line reference wavelength is fd, and a sum of axial distances between every two adjacent lens elements of the photographing lens assembly is ΣAT. When the following condition is satisfied: 1.6<fd/ΣAT<4.0, a balance between the total focal length and the arrangement of axial distances between the lens elements can be achieved, which is favorable for forming a wide-angle lens assembly with high image quality. Moreover, the following condition can be satisfied: 2.0<fd/ΣAT<3.2.

The focal length of the photographing lens assembly at d-line reference wavelength is fd, and a central thickness of the fourth lens element along the optical path is CT4. When the following condition is satisfied: 1.0<fd/CT4<4.0, the total focal length and the thickness of the photographing lens assembly can be effectively balanced, which is favorable for correcting aberrations of the optical system and achieving miniaturization. Moreover, the following condition can be satisfied: 2.0<fd/CT4<3.7.

A focal length of the first lens element at d-line reference wavelength is f1d, and a focal length of the second lens element at d-line reference wavelength is f2d. When the following condition is satisfied: −3.0<f1d/f2d<−0.08, the refractive power distribution of the first lens element can be enhanced, and the aberration generated by the first lens element can be balanced by the second lens element. Moreover, the following condition can be satisfied: −2.0<f1d/f2d<−0.5.

The focal length of the second lens element at d-line reference wavelength is f2d, and a focal length of the fourth lens element at d-line reference wavelength is f4d. When the following condition is satisfied: |f2d/f4d|<1.25, the refractive power distribution of the second lens element and the fourth lens element can be balanced, so that image quality can be favorably improved. Moreover, the following condition can be satisfied: 0.05<|f2d/f4d|<0.9. Moreover, the following condition can be satisfied: 0.08<|f2d/f4d|<0.6.

The focal length of the first lens element at d-line reference wavelength is f1d, and a curvature radius of the image-side surface of the first lens element is R2. When the following condition is satisfied: −2.6<f1d/R2<0, the refractive power and surface shapes of the first lens element can have a balanced arrangement, which is favorable for increasing the symmetry of the optical system and reducing lens flares at the central field. Moreover, the following condition can be satisfied: −2.8<f1d/R2<−0.1. Moreover, the following condition can be satisfied: −2.1<f1d/R2<−0.2.

The focal length of the first lens element at d-line reference wavelength is f1d, and a curvature radius of the image-side surface of the second lens element is R4. When the following condition is satisfied: 0.3<|f1d/R4|<5.4, the refractive power of the first lens element and the surface shapes of the second lens element can be adjusted to improve image quality. Moreover, the following condition can be satisfied: 0.5<|f1d/R4|<5.0.

A curvature radius of the object-side surface of the first lens element is R1, and a curvature radius of the image-side surface of the first lens element is R2. When the following condition is satisfied: −1.5<(R1+R2)/(R1−R2)<1.4, the curvature radius on the object side and the curvature radius on the image side of the first lens element can be effectively balanced to control the optical path direction. Moreover, the following condition can be satisfied: −1.0<(R1+R2)/(R1−R2)<1.2.

A curvature radius of the object-side surface of the second lens element is R3, and a curvature radius of the image-side surface of the second lens element is R4. When the following condition is satisfied: −0.48<(R3−R4)/(R3+R4)<1.60, the curvature radius on the object side and the curvature radius on the image side of the second lens element can be adjusted to achieve miniaturization. Moreover, the following condition can be satisfied: −0.3<(R3−R4)/(R3+R4)<1.45. Moreover, the following condition can be satisfied: 0.10<(R3−R4)/(R3+R4)<1.40.

A curvature radius of the image-side surface of the third lens element is R6, and a curvature radius of the image-side surface of the fourth lens element is R8. When the following condition is satisfied: −15.0<(R6−R8)/(R6+R8)<5.0, the surface shapes of the third lens element and the fourth lens element can be effectively balanced to improve light convergence results at the center of the image. Moreover, the following condition can be satisfied: −10.0<(R6−R8)/(R6+R8)<3.0.

A central thickness of the first lens element along the optical path is CT1, a central thickness of the third lens element along the optical path is CT3, and a central thickness of the fourth lens element along the optical path is CT4. When the following condition is satisfied: 0.82< (CT1+CT4)/CT3<2.0, the ratio of the central thicknesses of the first lens element, the third lens element and the fourth lens element can be balanced, which is favorable for an optimal space arrangement. Moreover, the following condition can be satisfied: 0.88<(CT1+CT4)/CT3<1.6.

The central thickness of the first lens element along the optical path is CT1, and the central thickness of the third lens element along the optical path is CT3. When the following condition is satisfied: 0.4<CT1/CT3<0.7, the ratio of the central thicknesses of the first lens element and the third lens element can be balanced to control the size of the optical system. Moreover, the following condition can be satisfied: 0.42<CT1/CT3<0.65.

An axial distance between the first lens element and the second lens element is T12, and the central thickness of the first lens element along the optical path is CT1. When the following condition is satisfied: 0.2<T12/CT1<1.7, the first lens element can have sufficient space to allow increased flexibility in design. Moreover, the following condition can be satisfied: 0.5<T12/CT1<1.5.

The axial distance between the first lens element and the second lens element is T12, and the central thickness of the fourth lens element along the optical path is CT4. When the following condition is satisfied: 0.2<T12/CT4<1.5, the ratio of the thickness of the fourth lens element to the axial distance between the first lens element and the second lens element can be adjusted, which can help balance assembly errors and manufacturability of the fourth lens element. Moreover, the following condition can be satisfied: 0.5<T12/CT4<1.2.

The axial distance between the first lens element and the second lens element is T12, an axial distance between the second lens element and the third lens element is T23, and an axial distance between the third lens element and the fourth lens element is T34. When the following condition is satisfied: 1.6<T12/(T23+T34)<5.0, the proportion of the axial distance between the first lens element and the second lens element in the space of the photographing lens assembly can be adjusted, so that sufficient space can be provided for light convergence to favorably correct aberrations. Moreover, the following condition can be satisfied: 2.0<T12/(T23+T34)<4.5.

The axial distance between the first lens element and the second lens element is T12, the axial distance between the second lens element and the third lens element is T23, and the axial distance between the third lens element and the fourth lens element is T34. When the following condition is satisfied: 0.01<T23/(T12+T34)<0.45, the lens elements can be coordinated with each other to reduce the size of the photographing lens assembly. Moreover, the following condition can be satisfied: 0.05<T23/(T12+T34)<0.3.

A sum of the central thicknesses of the first lens element, the second lens element, the third lens element, and the fourth lens element along the optical path is ΣCT, and the sum of axial distances between every two adjacent lens elements of the photographing lens assembly is ΣAT. When the following condition is satisfied: 2.8<ΣCT/ΣAT<5.5, distribution of the lens elements can be favorably adjusted and a balance between the thicknesses of the lens elements and axial distances between the lens elements can be achieved, so that the space of the photographing lens assembly can be utilized more efficiently. Moreover, the following condition can be satisfied: 3.0<ΣCT/Σ<4.8. Moreover, the following condition can be satisfied: 3.2<ΣCT/Σ<4.5.

An Abbe number of the second lens element at d-line reference wavelength is V2d, and an Abbe number of the fourth lens element at d-line reference wavelength is V4d. When the following condition is satisfied: 0.5<V2d/V4d<1.5, the focal points of light with different wavelengths can be effectively corrected to avoid image overlapping. Moreover, the following condition can be satisfied: 0.8<V2d/V4d<1.3.

The Abbe number of the fourth lens element at d-line reference wavelength is V4d. When the following condition is satisfied: 10.0<V4d<24.0, the arrangement regarding the materials of the lens elements can be adjusted, which is favorable for reducing the size of the photographing lens assembly and correcting aberrations, in particular for applications involving the wavelength range of infrared light. Moreover, the following condition can be satisfied: 15.0<V4d<22.0.

A displacement in parallel with the optical axis from an axial vertex on the object-side surface of the first lens element to a boundary of the optically effective area of the object-side surface of the first lens element is SAG1R1, and a maximum effective radius on the object-side surface of the first lens element is Y1R1. When the following condition is satisfied: 0.05<|SAG1R1|/Y1R1<0.2, the curvature of the peripheral surface on the object side of the first element can be balanced, so that light refraction angle can be suppressed to improve light convergence results in the peripheral region. Moreover, the following condition can be satisfied: 0.08<|SAG1R1|/Y1R1<0.18.

A displacement in parallel with the optical axis from an axial vertex on the image-side surface of the first lens element to a boundary of the optically effective area of the image-side surface of the first lens element is SAG1R2, and the central thickness of the first lens element along the optical path is CT1. When the following condition is satisfied: 0.2<|SAG1R2|/CT1<1.2, the central thickness of the first lens element and the curvature of the peripheral surface on the image side thereof can be balanced, which is favorable for controlling the optical path of each field incident on the image surface and further enhancing illuminance at the image periphery. Moreover, the following condition can be satisfied: 0.4<|SAG1R2|/CT1<0.9.

A maximum effective radius on the image-side surface of the fourth lens element is Y4R2, and the central thickness of the fourth lens element along the optical path is CT4. When the following condition is satisfied: 0.5<Y4R2/CT4<2.0, distortions can be corrected to avoid deformation at the image periphery. Moreover, the following condition can be satisfied: 1.0<Y4R2/CT4<1.8.

An Abbe number of a lens element at d-line reference wavelength is Vd. When at least two lens elements among the first through fourth lens elements of the photographing lens assembly satisfy the following condition: Vd<22.0, chromatic aberrations of the optical system can be corrected to improve image quality favorably. Moreover, the following can be satisfied: Vd<21.0.

When an aperture stop is disposed between the second lens element and the third lens element, it can limit the imaging range and the incident angle of light on an image surface so as to achieve high image brightness.

The present disclosure provides an imaging apparatus comprising the aforementioned photographing lens assembly and an image sensor disposed on or near the image surface. The imaging apparatus according to the present disclosure can be used for light in the wavelength range of 700-1000 nm, and particularly the wavelength range of 750-950 nm, and more particularly the wavelength range of 800-900 nm.

The present disclosure further provides an electronic device comprising three or more imaging apparatuses, wherein the three or more imaging apparatuses include the aforementioned imaging apparatus and face the same direction, so that telephoto and wide-angle features can be provided.

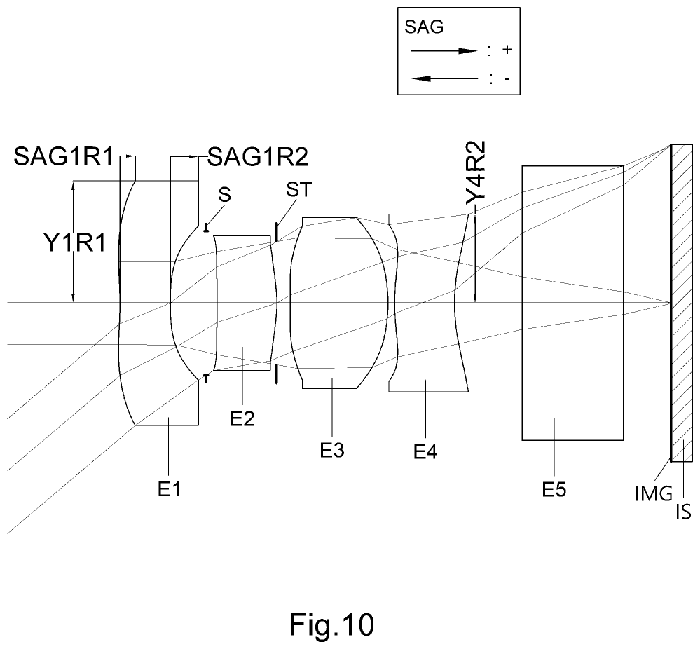

FIG. 10 is a schematic view illustrating the parameters SAG1R1, Y1R1, SAG1R2 and Y4R2 of the photographing lens assembly, with the 1st embodiment of the present disclosure as an example. A displacement in parallel with the optical axis from an axial vertex on the object-side surface of the first lens element to a boundary of the optically effective area of the object-side surface of the first lens element is SAG1R1, wherein a displacement toward the image side has a positive value and a displacement toward the object side has a negative value: a maximum effective radius on the object-side surface of the first lens element is Y1R1: a displacement in parallel with the optical axis from an axial vertex on the image-side surface of the first lens element to a boundary of the optically effective area of the image-side surface of the first lens element is SAG1R2; and a maximum effective radius on the image-side surface of the fourth lens element is Y4R2.

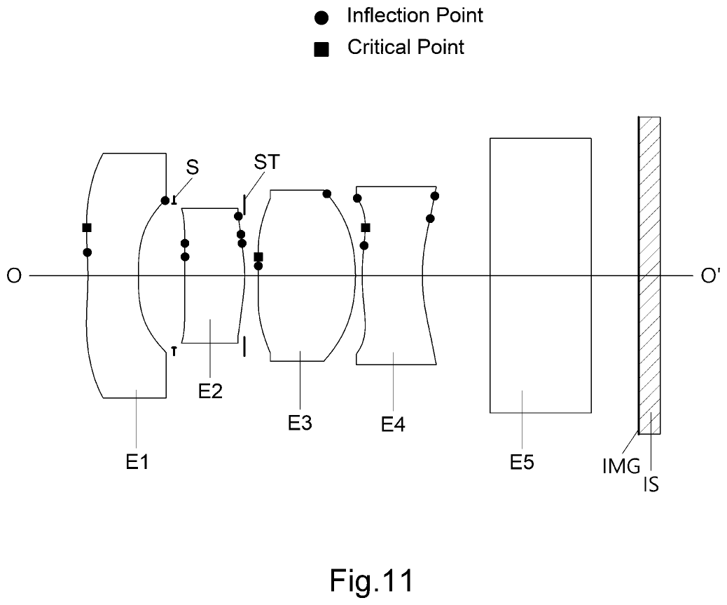

FIG. 11 is a schematic view illustrating the inflection points and critical points of the photographing lens assembly with the 1st embodiment of the present disclosure as an example, wherein the black circles mark the positions of the inflection points and the black squares mark the positions of the critical points. According to the photographing lens assembly of the present disclosure, an inflection point is a point on a surface of a lens element where the surface curvature changes from being positive to being negative, or vice versa; and a critical point is a point on a surface of a lens element that is tangent to a tangent plane perpendicular to the optical axis, exclusive of the intersection of the aforementioned surface and the optical axis.

The aforementioned features of the photographing lens assembly can be utilized in numerous combinations so as to achieve corresponding effects.

According to the photographing lens assembly of the present disclosure, the object side and the image side refer to the direction along the optical axis.

According to the photographing lens assembly of the present disclosure, the optical elements thereof can be made of glass or plastic material. When the optical elements are made of glass material, the distribution of the refractive power of the photographing lens assembly may be more flexible to design and the effect of external environmental temperature on imaging can be reduced. Technologies such as grinding or molding can be used for producing glass optical elements. When the optical elements are made of plastic material, manufacturing costs can be effectively reduced. Furthermore, surfaces of each optical element can be arranged to be spherical or aspheric (ASP). Arranging the spherical surfaces can reduce difficulties in manufacturing while arranging the aspheric surfaces can result in more control variables for eliminating aberrations and to further decrease the required quantity of optical elements; also, the total track length of the photographing lens assembly can be effectively reduced. Processes such as plastic injection molding or molded glass lens can be used for making the aspheric surfaces.

According to the photographing lens assembly of the present disclosure, if a surface of an optical element is aspheric, it means that the surface has an aspheric shape throughout its optically effective area, or a portion(s) thereof.

According to the photographing lens assembly of the present disclosure, additives may be selectively added to the material of any one (or more) optical element to produce light absorption or light interference effects, so as to change the transmittance of said optical element in a particular wavelength range of light, and to further reduce stray light and chromatic aberrations. For example, an additive that can filter off light in the wavelength range of 600-800 nm may be added to reduce extra red or infrared light, or an additive that can filter off light in the wavelength range of 350-450 nm may be added to reduce blue or ultraviolet light in the optical elements. Thus, additives can prevent unwanted disrupting light in particular wavelength ranges affecting the final image. In addition, additives may be evenly mixed in the plastic material for manufacturing optical elements with an injection molding process. In addition, additives may also be added to a coating on the surface of a lens element to provide the aforementioned effects.

According to the photographing lens assembly of the present disclosure, the photographing lens assembly can include at least one stop, such as an aperture stop, a glare stop or a field stop, so as to favorably reduce the amount of stray light and thereby improve the image quality.

According to the photographing lens assembly of the present disclosure, an aperture stop can be configured as a front stop or a middle stop. The front stop disposed between an imaged object and the first optical element can provide a longer distance between an exit pupil of the photographing lens assembly and the image surface, so that the generated telecentric effect can improve the image-sensing efficiency of an image sensor, such as a CCD or CMOS sensor. The middle stop disposed between the first optical element and the image surface is favorable for enlarging the field of view of the photographing lens assembly, thereby providing the photographing lens assembly with the advantage of a wide-angle lens.

An aperture control unit may be disposed in the photographing lens assembly of the present disclosure. The aperture control unit may be a mechanical part or optical moderation part, in which the size and shape of the aperture may be controlled by electricity or electronic signals. The mechanical part may include moving parts such as blades, shielding sheets, etc. The optical moderation part may include shielding materials such as filters, electrochromic materials, liquid crystal layers, etc. The aperture control unit can control the amount of incoming light and exposure time so as to further improve the image quality. Meanwhile, the aperture control unit may represent the aperture in the present disclosure that can adjust the image properties such as depth of field or exposure speed by changing the f-number of the photographing lens assembly.

According to the photographing lens assembly of the present disclosure, when the optical element has a convex surface and the region of convex shape is not specified, it indicates that the surface can be convex in the paraxial region thereof. When the optical element has a concave surface and the region of concave shape is not specified, it indicates that the surface can be concave in the paraxial region thereof. Likewise, when the region of refractive power or focal length of an optical element is not specified, it indicates that the region of refractive power or focal length of the optical element can be in the paraxial region thereof.

According to the photographing lens assembly of the present disclosure, at least one optical element capable of altering the optical path, such as a prism or a reflective mirror, can be optionally provided on the optical path between the imaged object and the image surface, wherein the surface shape of the prism or reflective mirror can be flat, spherical, aspheric or freeform. Then, the photographing lens assembly can be provided with more flexibility for its space arrangement, so that minimization of electronic devices is not limited by the total track length of the photographing lens assembly.

According to the photographing lens assembly of the present disclosure, the image surface of the photographing lens assembly, based on the corresponding image sensor, can be a plane or a curved surface with an arbitrary curvature, especially a curved surface being concave facing the object side. Meanwhile, the photographing lens assembly of the present disclosure may optionally include one or more image correction components (such as a field flattener) between the image surface and the optical element closest to the image surface for the purpose of image corrections (such as field curvature correction). The optical properties of the image correction components such as curvatures, thicknesses, indices, positions and shapes (convex or concave, spherical or aspheric, diffractive surface and Fresnel surface, etc.) can be adjusted according to the requirement of the imaging apparatus. Preferably, an image correction component may be a thin plano-concave component having a surface being concave toward the object side and arranged near the image surface.

One or more optical elements can be provided in the photographing lens assembly of the present disclosure to limit the forms of light passing through the system. The aforementioned optical element may be (but is not limited to) a filter or a polarizer, and may be provided in the form of a single piece, a composite component or a thin film, but is not limited thereto. The aforementioned optical element can be disposed on the object side or image side of the photographing lens assembly or alternatively between the lens elements of the assembly to control specific forms of light to pass through, so as to meet different application needs.

The photographing lens assembly of the present disclosure can comprise at least one of an optical lens element, an optical element or a carrier, which includes a low reflection layer disposed on at least one surface thereof. The low reflection layer can effectively reduce the stray light generated by light reflection at the interface. The low reflection layer can be disposed on the non-effective area of the object-side surface or the image-side surface of the aforementioned optical lens element, or on a connecting surface between the object-side surface and the image-side surface. The aforementioned optical element can be a light blocking element, an annular spacer element, a barrel element, a cover glass, a blue glass, a filter/color filter, an optical path folding element, a prism, or a mirror. The aforementioned carrier can be a lens assembly carrier, a micro lens disposed on the image sensor, or a glass sheet surrounding the substrate of the image sensor or used for protecting the image sensor.

According to the above description of the present disclosure, the following specific embodiments are provided for further explanation.

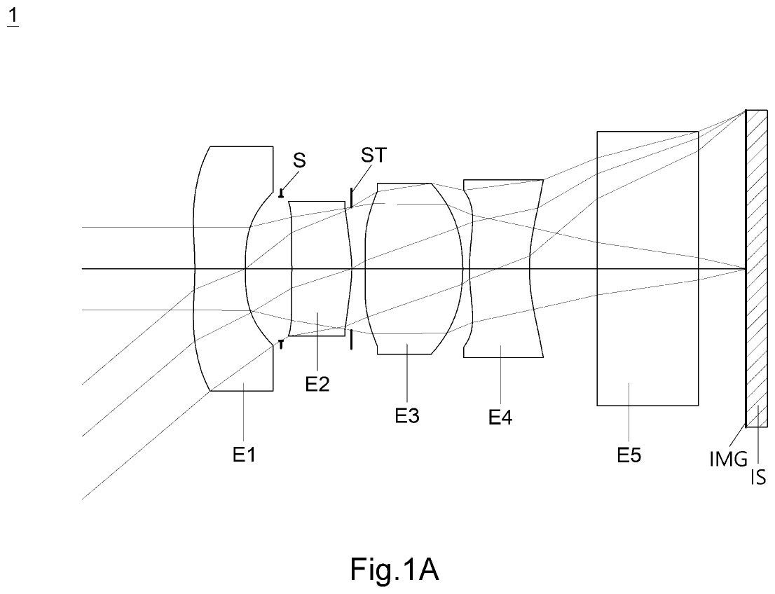

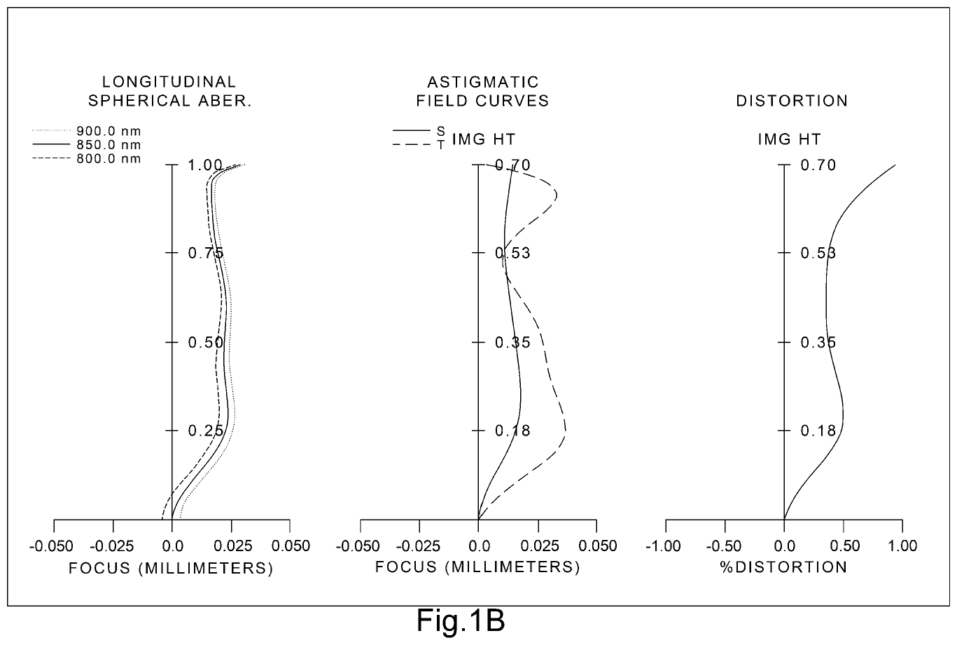

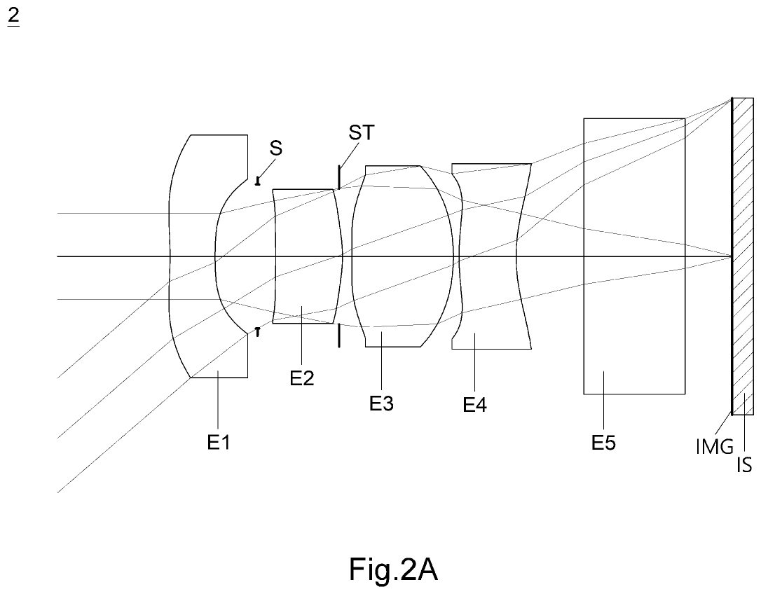

FIG. 1A is a schematic view of an imaging apparatus 1 according to the 1st embodiment of the present disclosure. FIG. 1B shows, in order from left to right, longitudinal spherical aberration curves, astigmatic field curves and a distortion curve of the imaging apparatus 1 according to the 1st embodiment.

In FIG. 1A, the imaging apparatus 1 includes a photographing lens assembly of the present disclosure and an image sensor IS. The photographing lens assembly includes, in order from an object side to an image side along an optical path, a first lens element E1, a stop S1, a second lens element E2, an aperture stop ST, a third lens element E3, a fourth lens element E4, a filter E5, and an image surface IMG.

The first lens element E1 has negative refractive power and is made of plastic material. The first lens element E1 has an object-side surface being concave in a paraxial region thereof and having one inflection point and one critical point, and an image-side surface being concave in a paraxial region thereof and having one inflection point. Both the object-side surface and the image-side surface are aspheric.

The second lens element E2 has positive refractive power and is made of plastic material. The second lens element E2 has an object-side surface being concave in a paraxial region thereof and having two inflection points, and an image-side surface being convex in a paraxial region thereof and having three inflection points. Both the object-side surface and the image-side surface are aspheric.

The third lens element E3 has positive refractive power and is made of plastic material. The third lens element E3 has an object-side surface being concave in a paraxial region thereof and having one inflection point and one critical point, and an image-side surface being convex in a paraxial region thereof and having one inflection point. Both the object-side surface and the image-side surface are aspheric.

The fourth lens element E4 has negative refractive power and is made of plastic material. The fourth lens element E4 has an object-side surface being convex in a paraxial region thereof and having two inflection points and one critical point, and an image-side surface being concave in a paraxial region thereof and having two inflection points. Both the object-side surface and the image-side surface are aspheric.

The filter E5 is disposed between the fourth lens element E4 and the image surface IMG. The filter E5 is made of glass material and does not affect the focal length of the photographing lens assembly. The image sensor IS is disposed on or near the image surface IMG.

The detailed optical data of the 1st embodiment are shown in TABLE 1A, wherein the units of the curvature radius, the thickness and the focal length are expressed in mm, f is a focal length of the photographing lens assembly, Fno is an f-number of the photographing lens assembly, HFOV is half of the maximum field of view, fd is a focal length of the photographing lens assembly at d-line reference wavelength, TLd is an axial distance between the object-side surface of the first lens element and the image surface at d-line reference wavelength, BLd is a back focal length of the photographing lens assembly at d-line reference wavelength, and surfaces #0 to #13 refer to the surfaces in order from the object side to the image side. The aspheric surface data are shown in TABLE 1B, wherein k is the conic coefficient in the equation of the aspheric surface profiles, and A4-A22 refer to the 4th to 22nd order aspheric coefficients.

Further, it should be noted that the tables shown in each of the following embodiments are associated with the schematic view and diagrams of longitudinal spherical aberration curves, astigmatic field curves and a distortion curve for the respective embodiment. Also, the definitions of the parameters presented in later tables are the same as those of the parameters presented in TABLE 1A and TABLE 1B for the 1st embodiment. Explanations in this regard will not be provided again.

TABLE 1A
(1st Embodiment)
f = 0.81 mm, Fno = 2.20, HFOV = 40.3 deg./fd = 0.78 mm, TLd = 2.411 mm, BLd = 0.926 mm.

| Surface | | | | | | | Abbe | Focal | Index | Abbe # |
|---|---|---|---|---|---|---|---|---|---|---|
| # | | Curvature Radius | | Thickness | Material | Index | # | Length | (d-line) | (d-line) |
| 0 | Object | Plano | | 600.000 | | | | | | |
| 1 | Lens 1 | −1.5100 | (ASP) | 0.224 | Plastic | 1.619 | 23.5 | −1.13 | 1.639 | −1.10 |
| 2 | | 1.3876 | (ASP) | 0.159 | | | | | | |
| 3 | Stop | Plano | | 0.048 | | | | | | |
| 4 | Lens 2 | −7.8188 | (ASP) | 0.266 | Plastic | 1.645 | 19.5 | 1.01 | 1.669 | 0.98 |
| 5 | | −0.6113 | (ASP) | −0.001 | | | | | | |
| 6 | Ape. | Plano | | 0.061 | | | | | | |
| | Stop | | | | | | | | | |
| 7 | Lens 3 | −2.1289 | (ASP) | 0.432 | Plastic | 1.537 | 56.0 | 1.89 | 1.544 | 1.86 |
| 8 | | −0.7359 | (ASP) | 0.030 | | | | | | |
| 9 | Lens 4 | 0.9697 | (ASP) | 0.266 | Plastic | 1.645 | 19.5 | −85.82 | 1.669 | −98.05 |
| 10 | | 0.8505 | (ASP) | 0.300 | | | | | | |
| 11 | Filter | Plano | | 0.450 | Glass | 1.510 | 64.2 | — | 1.517 | — |
| 12 | | Plano | | 0.211 | | | | | | |
| 13 | Image | Plano | | — | | | | | | |
| | Surface | | | | | | | | | |

* Reference wavelength is 850.0 nm.
* The effective radius of the stop on Surface #3 is 0.320 mm.
* Reference wavelength is 587.6 nm (d-line).

TABLE 1B
Aspheric Coefficient

| Surface # | 1 | 2 | 4 | 5 |
|---|---|---|---|---|
| K= | −9.237840E+01 | 6.776350E+00 | 2.974840E+01 | −2.332360E+01 |
| A4= | 2.865444E+00 | 9.916929E+00 | 1.666757E+00 | 8.222536E−01 |
| A6= | −1.026158E+01 | −9.080223E+01 | 1.055785E+00 | 1.210395E+02 |
| A8= | 1.686137E+01 | 1.814675E+03 | −9.822270E+02 | −3.643680E+03 |
| A10= | 8.406853E+00 | −2.718204E+04 | 1.605009E+04 | 3.304301E+04 |
| A12= | −2.157393E+01 | 1.975195E+05 | −1.904146E+05 | 1.255528E+05 |
| A14= | −3.809263E+01 | −5.501293E+05 | 1.296299E+06 | −4.308250E+06 |
| A16= | | | −3.307579E+06 | 2.252403E+07 |
| Surface # | 7 | 8 | 9 | 10 |
| K= | 1.200160E+01 | −7.457550E+01 | −1.454480E+00 | −2.689450E+00 |
| A4= | 1.910058E+01 | −1.711084E+01 | −7.951997E−01 | 1.014576E+00 |
| A6= | −3.134946E+02 | 3.916355E+02 | −2.724656E+02 | −6.769288E+01 |
| A8= | 5.342346E+03 | −8.708647E+03 | 1.126924E+04 | 2.153008E+03 |
| A10= | −8.902884E+04 | 1.372350E+05 | −3.374166E+05 | −6.496116E+04 |
| A12= | 1.119312E+06 | −1.399058E+06 | 6.848230E+06 | 1.308663E+06 |
| A14= | −8.965869E+06 | 8.745253E+06 | −9.281864E+07 | −1.649013E+07 |
| A16= | 3.984421E+07 | −3.049646E+07 | 8.266632E+08 | 1.298679E+08 |
| A18= | −7.408707E+07 | 4.554981E+07 | −4.653993E+09 | −6.230782E+08 |
| A20= | | | 1.503221E+10 | 1.667846E+09 |
| A22= | | | −2.116614E+10 | −1.909786E+09 |

The equation of the aspheric surface profiles is expressed as follows:

$$X ( Y ) = ( {Y}^{2} / R ) / ( 1 + sqrt ( 1 - ( 1 + k ) * {( Y / R )}^{2} ) ) + {\sum }_{i} ( Ai ) * ( {Y}^{i} )$$

where:
X is the relative distance between a point on the aspheric surface spaced at a distance Y from the optical axis and the tangential plane at the aspheric surface vertex on the optical axis;
Y is the vertical distance from the point on the aspheric surface profile to the optical axis;
R is the curvature radius;
k is the conic coefficient; and
Ai is the i-th aspheric coefficient.

In the 1st embodiment, the focal length of the photographing lens assembly at d-line reference wavelength is fd, and the following condition is satisfied: fd=0.78 mm.

In the 1st embodiment, the f-number of the photographing lens assembly is Fno, and the following condition is satisfied: Fno=2.20.

In the 1st embodiment, the field of view of the photographing lens assembly at d-line reference wavelength is FOVd, and the following condition is satisfied: FOVd=82.7 degrees.

In the 1st embodiment, the axial distance between the object-side surface of the first lens element E1 and the image surface IMG at d-line reference wavelength is TLd, the entrance pupil diameter of the photographing lens assembly at d-line reference wavelength is EPDd, and the following condition is satisfied: TLd/EPDd=6.82.

In the 1st embodiment, the axial distance between the object-side surface of the first lens element E1 and the image surface IMG at d-line reference wavelength is TLd, the axial distance between the aperture stop ST and the image-side surface of the fourth lens element E4 is SD, and the following condition is satisfied: TLd/SD=3.06.

In the 1st embodiment, the axial distance between the object-side surface of the first lens element E1 and the image-side surface of the fourth lens element E4 is TD, the axial distance between the image-side surface of the fourth lens elements E4 and the image surface IMG at d-line reference wavelength is BLd, and the following condition is satisfied: TD/BLd=1.60.

In the 1st embodiment, the axial distance between the image-side surface of the fourth lens elements E4 and the image surface IMG at d-line reference wavelength is BLd, the axial distance between the aperture stop ST and the image-side surface of the fourth lens element E4 is SD, and the following condition is satisfied: BLd/SD=1.17.

In the 1st embodiment, the focal length of the photographing lens assembly at d-line reference wavelength is fd, the axial distance between the object-side surface of the first lens element E1 and the image surface IMG at d-line reference wavelength is TLd, and the following condition is satisfied: fd/TLd=0.32.

In the 1st embodiment, the focal length of the photographing lens assembly at d-line reference wavelength is fd, the sum of axial distances between every two adjacent lens elements of the photographing lens assembly is ΣAT, and the following condition is satisfied: fd/ΣAT=2.62.

In the 1st embodiment, the focal length of the photographing lens assembly at d-line reference wavelength is fd, the central thickness of the fourth lens element along the optical path is CT4, and the following condition is satisfied: fd/CT4=2.92.

In the 1st embodiment, the focal length of the first lens element E1 at d-line reference wavelength is f1d, the focal length of the second lens element E2 at d-line reference wavelength is f2d, and the following condition is satisfied: f1d/f2d=−1.13.

In the 1st embodiment, the focal length of the second lens element E2 at d-line reference wavelength is f2d, the focal length of the fourth lens element E4 at d-line reference wavelength is f4d, and the following condition is satisfied: |f2d/f4d|=0.01.

In the 1st embodiment, the focal length of the first lens element E1 at d-line reference wavelength is f1d, the curvature radius of the image-side surface of the first lens element E1 is R2, and the following condition is satisfied: f1d/R2=−0.79.

In the 1st embodiment, the focal length of the first lens element E1 at d-line reference wavelength is f1d, the curvature radius of the image-side surface of the second lens element E2 is R4, and the following condition is satisfied: |f1d/R4|=1.80.

In the 1st embodiment, the curvature radius of the object-side surface of the first lens element E1 is R1, the curvature radius of the image-side surface of the first lens element E1 is R2, and the following condition is satisfied: (R1+R2)/(R1−R2)=0.04.

In the 1st embodiment, the curvature radius of the object-side surface of the second lens element E2 is R3, the curvature radius of the image-side surface of the second lens element E2 is R4, and the following condition is satisfied: (R3−R4)/(R3+R4)=0.85.

In the 1st embodiment, the curvature radius of the image-side surface of the third lens element E3 is R6, the curvature radius of the image-side surface of the fourth lens element E4 is R8, and the following condition is satisfied: (R6−R8)/(R6+R8)=−13.84.

In the 1st embodiment, the central thickness of the first lens element E1 along the optical path is CT1, the central thickness of the fourth lens element E4 along the optical path is CT4, the central thickness of the third lens element E3 along the optical path is CT3, and the following condition is satisfied: (CT1+CT4)/CT3=1.13.

In the 1st embodiment, the central thickness of the first lens element E1 along the optical path is CT1, the central thickness of the third lens element E3 along the optical path is CT3, and the following condition is satisfied: CT1/CT3-0.52.

In the 1st embodiment, the axial distance between the first lens element E1 and the second lens element E2 is T12, the central thickness of the first lens element E1 along the optical path is CT1, and the following condition is satisfied: T12/CT1=0.92.

In the 1st embodiment, the axial distance between the first lens element E1 and the second lens element E2 is T12, the central thickness of the fourth lens element E4 along the optical path is CT4, and the following condition is satisfied: T12/CT4-0.78.

In the 1st embodiment, the axial distance between the first lens element E1 and the second lens element E2 is T12, the axial distance between the second lens element E2 and the third lens element E3 is T23, the axial distance between the third lens element E3 and the fourth lens element E4 is T34, and the following condition is satisfied: T12/(T23+T34)=2.30.

In the 1st embodiment, the axial distance between the first lens element E1 and the second lens element E2 is T12, the axial distance between the second lens element E2 and the third lens element E3 is T23, the axial distance between the third lens element E3 and the fourth lens element E4 is T34, and the following condition is satisfied: T23/(T12+T34)=0.25.

In the 1st embodiment, the sum of the central thicknesses of the first lens element E1, the second lens element E2, the third lens element E3, and the fourth lens element E4 along the optical path is ΣCT, the sum of axial distances between every two adjacent lens elements of the photographing lens assembly is ΣAT, and the following condition is satisfied: ΣCT/ΣAT=4.00.

In the 1st embodiment, the Abbe number of the second lens element E2 at d-line reference wavelength is V2d, the Abbe number of the fourth lens element E4 at d-line reference wavelength is V4d, and the following condition is satisfied: V2d/V4d=1.0.

In the 1st embodiment, the Abbe number of the fourth lens element E4 at d-line reference wavelength is V4d, and the following condition is satisfied: V4d=19.5.

In the 1st embodiment, the displacement in parallel with the optical axis from an axial vertex on the object-side surface of the first lens element E1 to a boundary of the optically effective area of the object-side surface of the first lens element E1 is SAG1R1, the maximum effective radius on the object-side surface of the first lens element E1 is Y1R1, and the following condition is satisfied: |SAG1R1|/Y1R1=0.13.

In the 1st embodiment, the displacement in parallel with the optical axis from an axial vertex on the image-side surface of the first lens element E1 to a boundary of the optically effective area of the image-side surface of the first lens element E1 is SAG1R2, the central thickness of the first lens element E1 along the optical path is CT1, and the following condition is satisfied: |SAG1R2|/CT1=0.56.

In the 1st embodiment, the maximum effective radius on the image-side surface of the fourth lens element E4 is Y4R2, the central thickness of the fourth lens element E4 along the optical path is CT4, and the following condition is satisfied: Y4R2/CT4=1.48.

### 2nd Embodiment

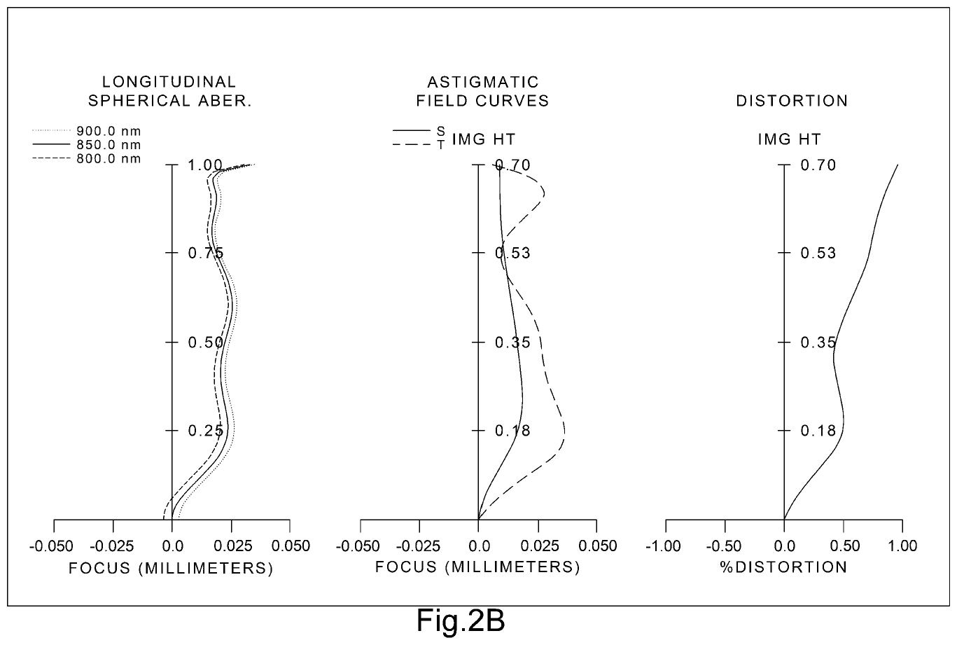

FIG. 2A is a schematic view of an imaging apparatus 2 according to the 2nd embodiment of the present disclosure. FIG. 2B shows, in order from left to right, longitudinal spherical aberration curves, astigmatic field curves and a distortion curve of the imaging apparatus 2 according to the 2nd embodiment.

In FIG. 2A, the imaging apparatus 2 includes a photographing lens assembly of the present disclosure and an image sensor IS. The photographing lens assembly includes, in order from an object side to an image side along an optical path, a first lens element E1, a stop S, a second lens element E2, an aperture stop ST, a third lens element E3, a fourth lens element E4, a filter E5, and an image surface IMG.

The first lens element E1 has negative refractive power and is made of plastic material. The first lens element E1 has an object-side surface being concave in a paraxial region thereof and having one inflection point and one critical point, and an image-side surface being concave in a paraxial region thereof and having one inflection point. Both the object-side surface and the image-side surface are aspheric.

The second lens element E2 has positive refractive power and is made of plastic material. The second lens element E2 has an object-side surface being concave in a paraxial region thereof, and an image-side surface being convex in a paraxial region thereof. Both the object-side surface and the image-side surface are aspheric.

The third lens element E3 has positive refractive power and is made of plastic material. The third lens element E3 has an object-side surface being concave in a paraxial region thereof and having two inflection points and one critical point, and an image-side surface being convex in a paraxial region thereof and having one inflection point. Both the object-side surface and the image-side surface are aspheric.

The fourth lens element E4 has negative refractive power and is made of plastic material. The fourth lens element E4 has an object-side surface being convex in a paraxial region thereof and having two inflection points and one critical point, and an image-side surface being concave in a paraxial region thereof. Both the object-side surface and the image-side surface are aspheric.

The filter E5 is disposed between the fourth lens element E4 and the image surface IMG. The filter E5 is made of glass material and does not affect the focal length of the photographing lens assembly. The image sensor IS is disposed on or near the image surface IMG.

The detailed optical data of the 2nd embodiment are shown in TABLE 2A, and the aspheric surface data are shown in TABLE 2B.

TABLE 2A
(2nd Embodiment)
f = 0.79 mm, Fno = 2.08, HFOV = 40.9 deg./fd = 0.76 mm, TLd = 2.465 mm, BLd = 0.929 mm.

| | | | | | | | | | | Focal |
|---|---|---|---|---|---|---|---|---|---|---|
| Surface | | | | | | | Abbe | Focal | Index | Length |
| # | | Curvature Radius | | Thickness | Material | Index | # | Length | (d-line) | (d-line) |
| 0 | Object | Plano | | 600.000 | | | | | | |
| 1 | Lens 1 | −1.4318 | (ASP) | 0.200 | Plastic | 1.619 | 23.5 | −1.21 | 1.639 | −1.17 |
| 2 | | 1.6614 | (ASP) | 0.189 | | | | | | |
| 3 | Stop | Plano | | 0.080 | | | | | | |
| 4 | Lens 2 | −5.8587 | (ASP) | 0.297 | Plastic | 1.619 | 23.5 | 0.99 | 1.639 | 0.96 |
| 5 | | −0.5653 | (ASP) | −0.015 | | | | | | |
| 6 | Ape. | Plano | | 0.057 | | | | | | |
| | Stop | | | | | | | | | |
| 7 | Lens 3 | −2.1536 | (ASP) | 0.449 | Plastic | 1.537 | 56.0 | 1.88 | 1.544 | 1.86 |
| 8 | | −0.7380 | (ASP) | 0.025 | | | | | | |
| 9 | Lens 4 | 1.0247 | (ASP) | 0.254 | Plastic | 1.645 | 19.5 | −8.86 | 1.669 | −8.68 |
| 10 | | 0.7845 | (ASP) | 0.300 | | | | | | |
| 11 | Filter | Plano | | 0.450 | Glass | 1.510 | 64.2 | | 1.517 | |
| 12 | | Plano | | 0.208 | | | | | | |
| 13 | Image | Plano | | — | | | | | | |
| | Surface | | | | | | | | | |

* Reference wavelength is 850.0 nm.
* The effective radius of the stop on Surface #3 is 0.320 mm.
* Reference wavelength is 587.6 nm (d-line).

TABLE 2B
Aspheric Coefficient

| Surface # | 1 | 2 | 4 | 5 |
|---|---|---|---|---|
| K= | −9.636650E+01 | 1.646080E+01 | −9.900000E+01 | −1.773390E+01 |
| A4= | 3.519920E+00 | 1.078294E+01 | 1.161982E+00 | 4.823968E+00 |
| A6= | −1.441255E+01 | −1.104385E+02 | −4.743915E+01 | −7.759892E+01 |
| A8= | 5.219188E+01 | 2.200999E+03 | 1.519140E+03 | 1.350196E+03 |
| A10= | −1.638377E+02 | −2.858372E+04 | −4.142467E+04 | −4.326578E+04 |
| A12= | 3.801232E+02 | 1.980632E+05 | 5.563330E+05 | 7.418234E+05 |
| A14= | −4.086651E+02 | −5.643845E+05 | −3.743633E+06 | −5.979009E+06 |
| A16= | | | 9.776761E+06 | 1.854749E+07 |
| Surface # | 7 | 8 | 9 | 10 |
| K= | 1.175730E+01 | −8.313650E+01 | 6.801480E−01 | −2.802330E+00 |
| A4= | 2.235122E+01 | −1.652308E+01 | 4.466819E−01 | 3.745601E−01 |
| A6= | −4.463847E+02 | 3.851759E+02 | −3.612914E+02 | −4.116715E+01 |
| A8= | 8.038541E+03 | −7.799773E+03 | 1.528645E+04 | 1.233809E+03 |
| A10= | −1.192504E+05 | 1.106311E+05 | −4.355855E+05 | −3.979983E+04 |
| A12= | 1.254426E+06 | −1.018951E+06 | 8.261488E+06 | 8.341693E+05 |
| A14= | −8.363262E+06 | 5.747907E+06 | −1.041498E+08 | −1.058337E+07 |
| A16= | 3.112376E+07 | −1.801637E+07 | 8.598280E+08 | 8.216197E+07 |
| A18= | −4.888577E+07 | 2.403792E+07 | −4.463984E+09 | −3.829372E+08 |
| A20= | | | 1.321074E+10 | 9.845953E+08 |
| A22= | | | −1.694799E+10 | −1.072778E+09 |

In the 2nd embodiment, the equation of the aspheric surface profiles of the aforementioned lens elements is the same as the equation of the 1st embodiment. Also, the definitions of these parameters shown in the table below are the same as those stated in the 1st embodiment with corresponding values for the 2nd embodiment, so an explanation in this regard will not be provided again.

Moreover, these parameters can be calculated from TABLE 2A and TABLE 2B and satisfy the conditions stated in TABLE 2C below.

TABLE 2C

| | | | |
|---|---|---|---|
| fd [mm] | 0.76 | (R3 − R4)/(R3 + R4) | 0.82 |
| Fno | 2.08 | (R6 − R8)/(R6 + R8) | −32.74 |
| FOVd [deg.] | 83.7 | (CT1 + CT4)/CT3 | 1.01 |
| TLd/EPDd | 6.70 | CT1/CT3 | 0.45 |
| TLd/SD | 3.14 | T12/CT1 | 1.35 |
| TD/BLd | 1.65 | T12/CT4 | 1.06 |
| BLd/SD | 1.18 | T12/(T23 + T34) | 4.01 |
| fd/TLd | 0.31 | T23/(T12 + T34) | 0.14 |
| fd/ΣAT | 2.27 | ΣCT/ΣAT | 3.57 |
| fd/CT4 | 3.01 | V2d/V4d | 1.2 |
| f1d/f2d | −1.23 | V4d | 19.5 |
| \|f2d/f4d\| | 0.11 | \|SAG1R1\|/Y1R1 | 0.17 |
| f1d/R2 | −0.71 | \|SAG1R2\|/CT1 | 0.73 |
| \|f1d/R4\| | 2.08 | Y4R2/CT4 | 1.61 |
| (R1 + R2)/(R1 − R2) | −0.07 | | |

### 3rd Embodiment

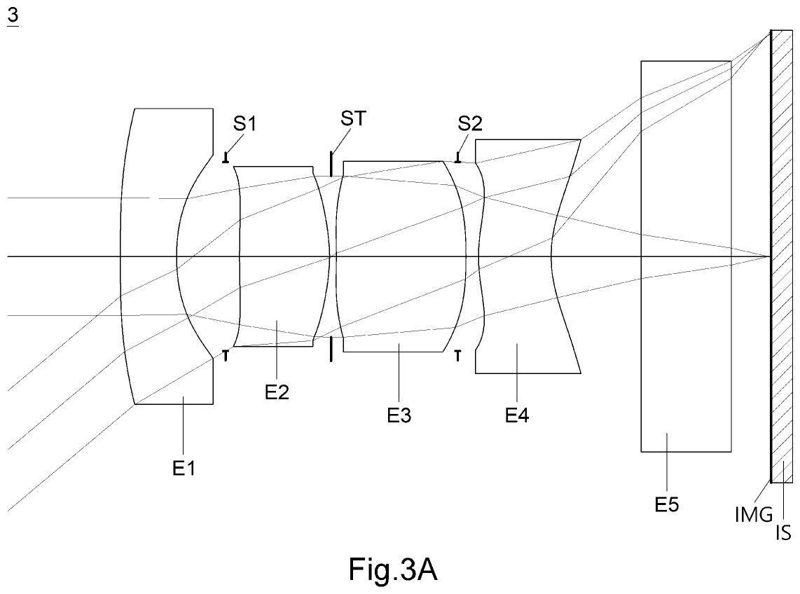

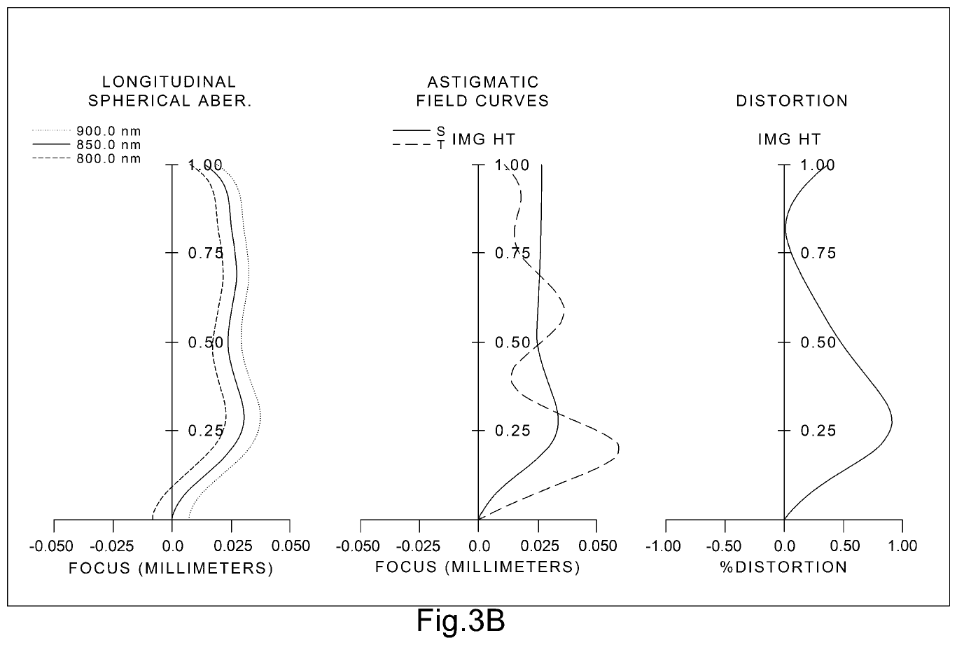

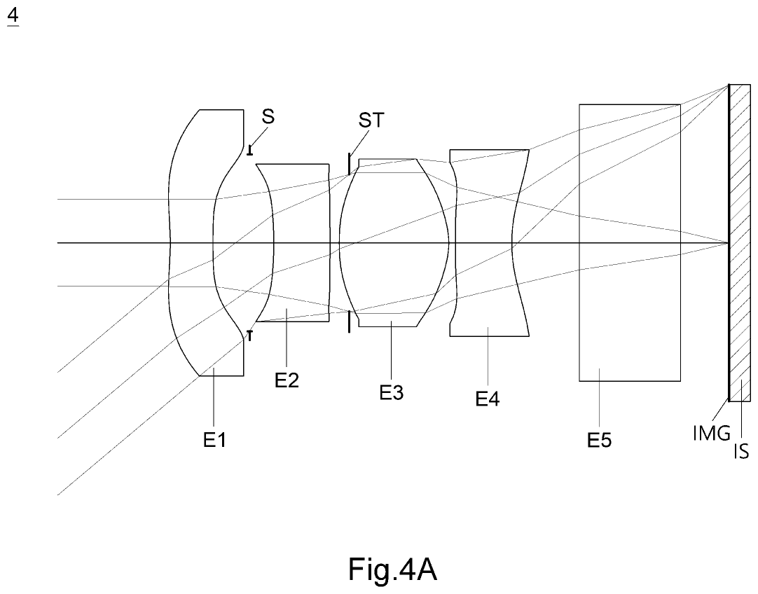

FIG. 3A is a schematic view of an imaging apparatus 3 according to the 3rd embodiment of the present disclosure. FIG. 3B shows, in order from left to right, longitudinal spherical aberration curves, astigmatic field curves and a distortion curve of the imaging apparatus according to the 3rd embodiment.

In FIG. 3A, the imaging apparatus 3 includes a photographing lens assembly of the present disclosure and an image sensor IS. The photographing lens assembly includes, in order from an object side to an image side along an optical path, a first lens element E1, a stop S1, a second lens element E2, an aperture stop ST, a third lens element E3, a stop S2, a fourth lens element E4, a filter E5, and an image surface IMG.

The first lens element E1 has negative refractive power and is made of plastic material. The first lens element E1 has an object-side surface being convex in a paraxial region thereof, and an image-side surface being concave in a paraxial region thereof and having one inflection point. Both the object-side surface and the image-side surface are aspheric.

The second lens element E2 has positive refractive power and is made of plastic material. The second lens element E2 has an object-side surface being convex in a paraxial region thereof and having one inflection point and one critical point, and an image-side surface being convex in a paraxial region thereof. Both the object-side surface and the image-side surface are aspheric.

The third lens element E3 has negative refractive power and is made of plastic material. The third lens element E3 has an object-side surface being concave in a paraxial region thereof and having one inflection point and one critical point, and an image-side surface being convex in a paraxial region thereof. Both the object-side surface and the image-side surface are aspheric.

The fourth lens element E4 has positive refractive power and is made of plastic material. The fourth lens element E4 has an object-side surface being convex in a paraxial region thereof and having one inflection point and one critical point, and an image-side surface being concave in a paraxial region thereof and having one inflection point. Both the object-side surface and the image-side surface are aspheric.

The filter E5 is disposed between the fourth lens element E4 and the image surface IMG. The filter E5 is made of glass material and does not affect the focal length of the photographing lens assembly. The image sensor IS is disposed on or near the image surface IMG.

The detailed optical data of the 3rd embodiment are shown in TABLE 3A, and the aspheric surface data are shown in TABLE 3B.

TABLE 3A
(3rd Embodiment)
f = 1.15 mm, Fno = 2.20, HFOV = 40.0 deg./fd = 1.08 mm, TLd = 2.819 mm, BLd = 0.906 mm.

| | | | | | | | | | | Focal |
|---|---|---|---|---|---|---|---|---|---|---|
| Surface | | | | | | | Abbe | Focal | Index | Length |
| # | | Curvature Radius | | Thickness | Material | Index | # | Length | (d-line) | (d-line) |
| 0 | Object | Plano | | 600.000 | | | | | | |
| 1 | Lens 1 | 12.1677 | (ASP) | 0.250 | Plastic | 1.537 | 56.1 | −1.64 | 1.545 | −1.62 |
| 2 | | 0.8157 | (ASP) | 0.218 | | | | | | |
| 3 | Stop | Plano | | 0.062 | | | | | | |
| 4 | Lens 2 | 4.3593 | (ASP) | 0.400 | Plastic | 1.638 | 20.4 | 0.97 | 1.660 | 0.94 |
| 5 | | −0.6950 | (ASP) | 0.007 | | | | | | |
| 6 | Ape. | Plano | | 0.023 | | | | | | |
| | Stop | | | | | | | | | |
| 7 | Lens 3 | −2.6501 | (ASP) | 0.574 | Plastic | 1.537 | 56.0 | −19.69 | 1.544 | −19.46 |
| 8 | | −3.8048 | (ASP) | −0.036 | | | | | | |
| 9 | Stop | Plano | | 0.092 | | | | | | |
| 10 | Lens 4 | 0.6313 | (ASP) | 0.323 | Plastic | 1.638 | 20.4 | 10.05 | 1.660 | 9.26 |
| 11 | | 0.5608 | (ASP) | 0.400 | | | | | | |
| 12 | Filter | Plano | | 0.400 | Glass | 1.510 | 64.2 | — | 1.517 | — |
| 13 | | Plano | | 0.177 | | | | | | |
| 14 | Image | Plano | | — | | | | | | |
| | Surface | | | | | | | | | |

* Reference wavelength is 850.0 nm.
* The effective radius of the stop on Surface #3 is 0.420 mm.
* The effective radius of the stop on Surface #9 is 0.420 mm.
* Reference wavelength is 587.6 nm (d-line).

TABLE 3B
Aspheric Coefficient

| Surface # | 1 | 2 | 4 | 5 |
|---|---|---|---|---|
| K= | −9.900000E+01 | −1.403590E+01 | 9.798840E+01 | −7.722880E+00 |
| A4= | 6.237222E−01 | 4.141283E+00 | −9.439018E−01 | 4.068717E+00 |
| A6= | −1.550318E+00 | −1.795554E+01 | −1.248089E+01 | −9.215897E+01 |
| A8= | 2.083438E+00 | 6.901768E+01 | 2.112401E+02 | 1.182662E+03 |
| A10= | −1.074194E+00 | −1.560511E+02 | −2.950661E+03 | −1.121967E+04 |
| A12= | | | 2.100345E+04 | 7.097717E+04 |
| A14= | | | −7.929582E+04 | −2.583897E+05 |
| A16= | | | 1.248896E+05 | 4.045267E+05 |
| Surface # | 7 | 8 | 10 | 11 |
| K= | −7.510170E+01 | −7.111650E+01 | −3.797630E+01 | −1.317160E+00 |
| A4= | 9.340798E+00 | −7.854762E+00 | 5.709335E+00 | −1.792314E+00 |
| A6= | −1.423283E+02 | 8.892931E+01 | −2.584463E+02 | 1.655941E+00 |
| A8= | 1.743037E+03 | −8.042621E+02 | 5.005039E+03 | −9.926388E+01 |
| A10= | −1.524997E+04 | 4.898135E+03 | −6.367368E+04 | 2.078254E+03 |
| A12= | 8.635293E+04 | −1.766200E+04 | 5.282857E+05 | −1.925687E+04 |
| A14= | −2.783175E+05 | 3.090745E+04 | −2.810208E+06 | 9.974378E+04 |
| A16= | 3.851624E+05 | −1.446433E+04 | 9.152723E+06 | −2.986752E+05 |
| A18= | | | −1.650740E+07 | 4.832882E+05 |
| A20= | | | 1.260264E+07 | −3.271394E+05 |

In the 3rd embodiment, the equation of the aspheric surface profiles of the aforementioned lens elements is the same as the equation of the 1st embodiment. Also, the definitions of these parameters shown in the table below are the same as those stated in the 1st embodiment with corresponding values for the 3rd embodiment, so an explanation in this regard will not be provided again.

Moreover, these parameters can be calculated from TABLE 3A and TABLE 3B and satisfy the conditions stated in TABLE 3C below.

TABLE 3C

| | | | |
|---|---|---|---|
| fd [mm] | 1.08 | (R3 − R4)/(R3 + R4) | 1.38 |
| Fno | 2.20 | (R6 − R8)/(R6 + R8) | 1.35 |
| FOVd [deg.] | 83.2 | (CT1 + CT4)/CT3 | 1.00 |
| TLd/EPDd | 5.73 | CT1/CT3 | 0.44 |
| TLd/SD | 2.89 | T12/CT1 | 1.12 |
| TD/BLd | 2.11 | T12/CT4 | 0.87 |
| BLd/SD | 0.93 | T12/(T23 + T34) | 3.26 |
| fd/TLd | 0.38 | T23/(T12 + T34) | 0.09 |
| fd/ΣAT | 2.96 | ΣCT/ΣAT | 4.23 |
| fd/CT4 | 3.35 | V2d/V4d | 1.0 |
| f1d/f2d | −1.72 | V4d | 20.4 |
| \|f2d/f4d\| | 0.10 | \|SAG1R1\|/Y1R1 | 0.10 |
| f1d/R2 | −1.98 | \|SAG1R2\|/CT1 | 0.65 |
| \|f1d/R4\| | 2.33 | Y4R2/CT4 | 1.63 |
| (R1 + R2)/(R1 − R2) | 1.14 | | |

### 4th Embodiment

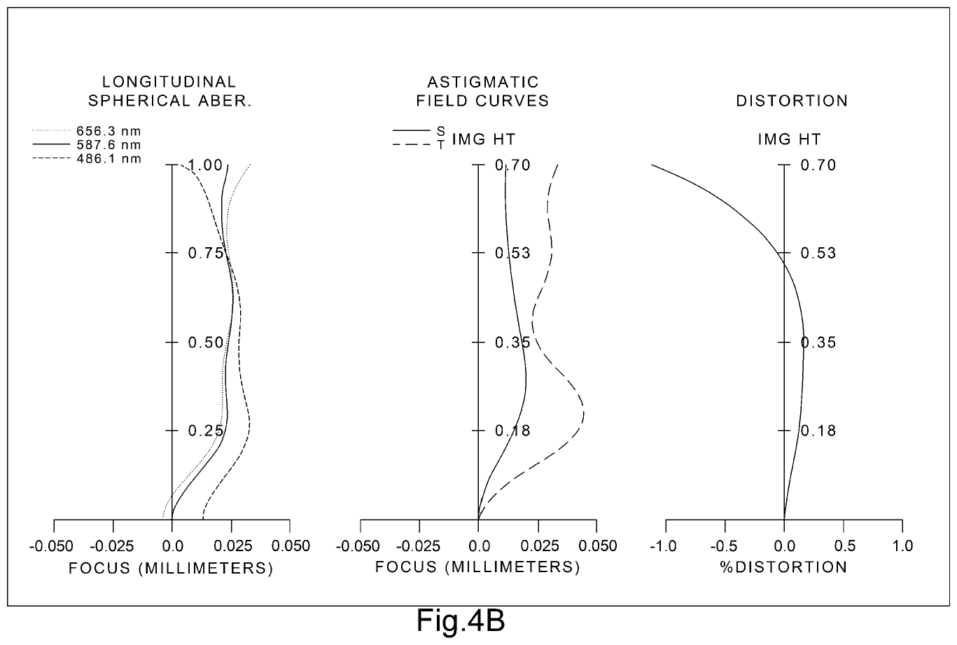

FIG. 4A is a schematic view of an imaging apparatus 4 according to the 4th embodiment of the present disclosure. FIG. 4B shows, in order from left to right, longitudinal spherical aberration curves, astigmatic field curves and a distortion curve of the imaging apparatus according to the 4th embodiment.

In FIG. 4A, the imaging apparatus 4 includes a photographing lens assembly of the present disclosure and an image sensor IS. The photographing lens assembly includes, in order from an object side to an image side along an optical path, a first lens element E1, a stop S, a second lens element E2, an aperture stop ST, a third lens element E3, a fourth lens element E4, a filter E5, and an image surface IMG.

The first lens element E1 has negative refractive power and is made of plastic material. The first lens element E1 has an object-side surface being concave in a paraxial region thereof and having two inflection points and one critical point, and an image-side surface being concave in a paraxial region thereof and having one inflection point. Both the object-side surface and the image-side surface are aspheric.

The second lens element E2 has negative refractive power and is made of plastic material. The second lens element E2 has an object-side surface being concave in a paraxial region thereof and having one inflection point, and an image-side surface being convex in a paraxial region thereof and having three inflection points and one critical point. Both the object-side surface and the image-side surface are aspheric.

The third lens element E3 has positive refractive power and is made of plastic material. The third lens element E3 has an object-side surface being convex in a paraxial region thereof, and an image-side surface being convex in a paraxial region thereof and having one inflection point. Both the object-side surface and the image-side surface are aspheric.

The fourth lens element E4 has negative refractive power and is made of plastic material. The fourth lens element E4 has an object-side surface being concave in a paraxial region thereof and having two inflection points and two critical points, and an image-side surface being concave in a paraxial region thereof and having one inflection point. Both the object-side surface and the image-side surface are aspheric.

The filter E5 is disposed between the fourth lens element E4 and the image surface IMG. The filter E5 is made of glass material and does not affect the focal length of the photographing lens assembly. The image sensor IS is disposed on or near the image surface IMG.

The detailed optical data of the 4th embodiment are shown in TABLE 4A, and the aspheric surface data are shown in TABLE 4B.

TABLE 4A
(4th Embodiment)
f = 0.83 mm, Fno = 2.15, HFOV = 40.1 deg.

| Surface | | | | | | | | Focal |
|---|---|---|---|---|---|---|---|---|
| # | | Curvature Radius | | Thickness | Material | Index | Abbe # | Length |
| 0 | Object | Plano | | 600.000 | | | | |
| 1 | Lens 1 | −1.2584 | (ASP) | 0.190 | Plastic | 1.544 | 56.0 | −1.97 |
| 2 | | 7.5688 | (ASP) | 0.163 | | | | |
| 3 | Stop | Plano | | 0.107 | | | | |
| 4 | Lens 2 | −1.5563 | (ASP) | 0.250 | Plastic | 1.639 | 23.5 | −6.72 |
| 5 | | −2.5949 | (ASP) | 0.085 | | | | |
| 6 | Ape. | Plano | | −0.044 | | | | |
| | Stop | | | | | | | |
| 7 | Lens 3 | 1.0136 | (ASP) | 0.485 | Plastic | 1.544 | 56.0 | 0.50 |
| 8 | | −0.3103 | (ASP) | 0.030 | | | | |
| 9 | Lens 4 | −3.1181 | (ASP) | 0.250 | Plastic | 1.669 | 19.5 | −0.80 |
| 10 | | 0.6670 | (ASP) | 0.300 | | | | |
| 11 | Filter | Plano | | 0.450 | Glass | 1.517 | 64.2 | — |
| 12 | | Plano | | 0.215 | | | | |
| 13 | Image | Plano | | — | | | | |
| | Surface | | | | | | | |

* Reference wavelength is d-line 587.6 nm.
* The effective radius of the stop on Surface #3 is 0.393 mm.

TABLE 4B
Aspheric Coefficient

| Surface # | 1 | 2 | 4 | 5 |
|---|---|---|---|---|
| K= | −2.479960E+00 | 9.900000E+01 | 1.220240E+01 | 5.130620E+01 |
| A4= | 6.292925E+00 | 8.944185E+00 | 2.131751E+00 | 1.194062E+01 |
| A6= | −3.733486E+01 | −2.510878E+01 | −7.738278E+01 | −3.353233E+02 |
| A8= | 1.798561E+02 | −2.280431E+02 | 6.695949E+02 | 5.602355E+03 |
| A10= | −5.758583E+02 | 4.309273E+03 | −6.992107E+03 | −7.219918E+04 |
| A12= | 1.063297E+03 | −2.851572E+04 | 3.825147E+04 | 7.192767E+05 |
| A14= | −8.398323E+02 | 6.092181E+04 | 8.802663E+04 | −4.492258E+06 |
| A16= | | | −8.467140E+05 | 1.298124E+07 |
| Surface # | 7 | 8 | 9 | 10 |
| K= | −6.951360E+01 | −9.793710E+00 | −6.244750E+01 | −3.007050E+00 |
| A4= | 2.103054E+01 | −1.951719E+00 | 2.520628E+01 | 1.142068E+00 |
| A6= | −5.492406E+02 | −8.910765E+01 | −1.038381E+03 | −5.324821E+01 |
| A8= | 1.092071E+04 | 2.503915E+03 | 2.802129E+04 | 6.221513E+02 |
| A10= | −1.638792E+05 | −4.009813E+04 | −5.462514E+05 | −5.115771E+03 |
| A12= | 1.737527E+06 | 4.068714E+05 | 7.297045E+06 | 2.474524E+04 |
| A14= | −1.195800E+07 | −2.512172E+06 | −6.462100E+07 | 2.178699E+04 |
| A16= | 4.741468E+07 | 8.514143E+06 | 3.604966E+08 | −1.046357E+06 |
| A18= | −8.164832E+07 | −1.179525E+07 | −1.141264E+09 | 5.240750E+06 |
| A20= | | | 1.558256E+09 | −8.718026E+06 |

In the 4th embodiment, the equation of the aspheric surface profiles of the aforementioned lens elements is the same as the equation of the 1st embodiment. Also, the definitions of these parameters shown in the table below are the same as those stated in the 1st embodiment with corresponding values for the 4th embodiment, so an explanation in this regard will not be provided again.

Moreover, these parameters can be calculated from TABLE 4A and TABLE 4B and satisfy the conditions stated in TABLE 4C below.

TABLE 4C

| | | | |
|---|---|---|---|
| fd [mm] | 0.83 | (R3 − R4)/(R3 + R4) | −0.25 |
| Fno | 2.15 | (R6 − R8)/(R6 + R8) | −2.74 |
| FOVd [deg.] | 80.1 | (CT1 + CT4)/CT3 | 0.91 |
| TLd/EPDd | 6.42 | CT1/CT3 | 0.39 |
| TLd/SD | 3.44 | T12/CT1 | 1.42 |
| TD/BLd | 1.57 | T12/CT4 | 1.08 |
| BLd/SD | 1.34 | T12/(T23 + T34) | 3.80 |
| fd/TLd | 0.33 | T23/(T12 + T34) | 0.14 |
| fd/ΣAT | 2.43 | ΣCT/ΣAT | 3.45 |
| fd/CT4 | 3.32 | V2d/V4d | 1.2 |
| f1d/f2d | 0.29 | V4d | 19.5 |
| \|f2d/f4d\| | 8.40 | \|SAG1R1\|/Y1R1 | 0.22 |
| f1d/R2 | −0.26 | \|SAG1R2\|/CT1 | 0.71 |
| \|f1d/R4\| | 0.76 | Y4R2/CT4 | 1.66 |
| (R1 + R2)/(R1 − R2) | −0.71 | | |

### 5th Embodiment

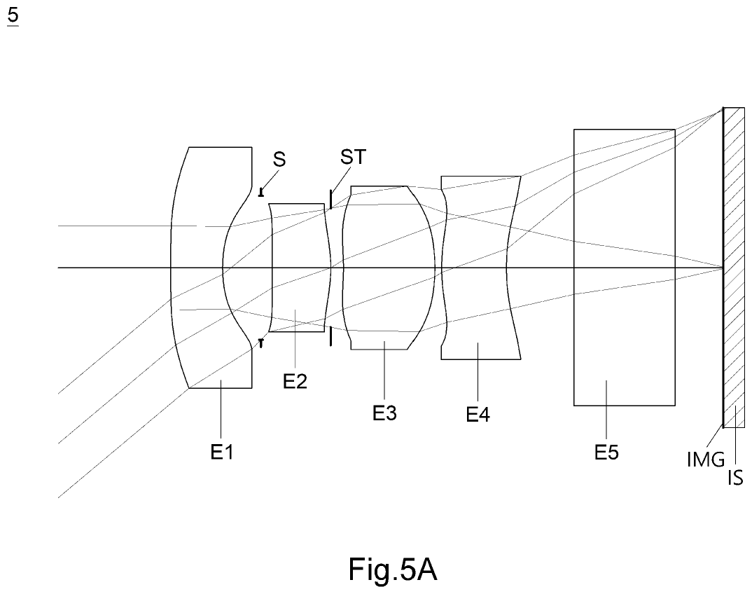

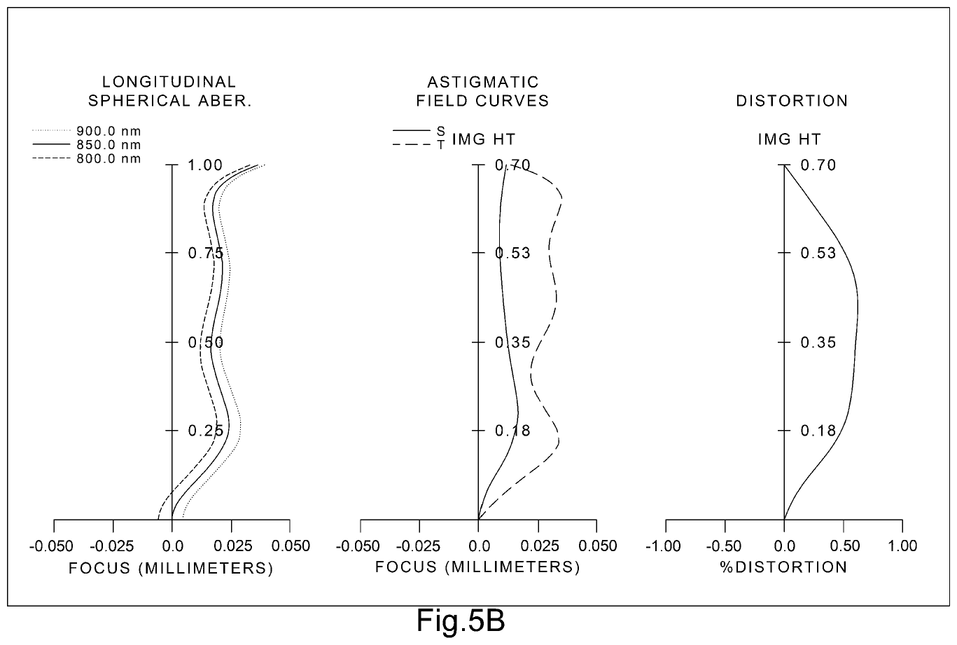

FIG. 5A is a schematic view of an imaging apparatus 5 according to the 5th embodiment of the present disclosure. FIG. 5B shows, in order from left to right, longitudinal spherical aberration curves, astigmatic field curves and a distortion curve of the imaging apparatus according to the 5th embodiment.

In FIG. 5A, the imaging apparatus 5 includes a photographing lens assembly of the present disclosure and an image sensor IS. The photographing lens assembly includes, in order from an object side to an image side along an optical path, a first lens element E1, a stop S, a second lens element E2, an aperture stop ST, a third lens element E3, a fourth lens element E4, a filter E5, and an image surface IMG.

The first lens element E1 has negative refractive power and is made of plastic material. The first lens element E1 has an object-side surface being convex in a paraxial region thereof and having one inflection point, and an image-side surface being concave in a paraxial region thereof and having one inflection point. Both the object-side surface and the image-side surface are aspheric.

The second lens element E2 has positive refractive power and is made of plastic material. The second lens element E2 has an object-side surface being convex in a paraxial region thereof and having one inflection point and one critical point, and an image-side surface being convex in a paraxial region thereof and having one inflection point. Both the object-side surface and the image-side surface are aspheric.

The third lens element E3 has positive refractive power and is made of plastic material. The third lens element E3 has an object-side surface being concave in a paraxial region thereof and having one inflection point and one critical point, and an image-side surface being convex in a paraxial region thereof and having one inflection point. Both the object-side surface and the image-side surface are aspheric.

The fourth lens element E4 has positive refractive power and is made of plastic material. The fourth lens element E4 has an object-side surface being convex in a paraxial region thereof and having one inflection point and one critical point, and an image-side surface being concave in a paraxial region thereof and having one inflection point. Both the object-side surface and the image-side surface are aspheric.

The filter E5 is disposed between the fourth lens element E4 and the image surface IMG. The filter E5 is made of glass material and does not affect the focal length of the photographing lens assembly. The image sensor IS is disposed on or near the image surface IMG.

The detailed optical data of the 5th embodiment are shown in TABLE 5A, and the aspheric surface data are shown in TABLE 5B.

TABLE 5A
(5th Embodiment)
f = 0.82 mm, Fno = 2.20, HFOV = 40.0 deg./fd = 0.79 mm, TLd = 2.407 mm, BLd = 0.916 mm.

| | | | | | | | | | | Focal |
|---|---|---|---|---|---|---|---|---|---|---|
| Surface | | | | | | | Abbe | Focal | Index | Length |
| # | | Curvature Radius | | Thickness | Material | Index | # | Length | (d-line) | (d-line) |
| 0 | Object | Plano | | 600.000 | | | | | | |
| 1 | Lens 1 | 100.0000 | (ASP) | 0.231 | Plastic | 1.537 | 56.1 | −1.14 | 1.545 | −1.13 |
| 2 | | 0.6088 | (ASP) | 0.170 | | | | | | |
| 3 | Stop | Plano | | 0.050 | | | | | | |
| 4 | Lens 2 | 18.8251 | (ASP) | 0.261 | Plastic | 1.638 | 20.4 | 0.91 | 1.660 | 0.88 |
| 5 | | −0.5962 | (ASP) | 0.000 | | | | | | |
| 6 | Ape. | Plano | | 0.056 | | | | | | |
| | Stop | | | | | | | | | |
| 7 | Lens 3 | −1.0595 | (ASP) | 0.405 | Plastic | 1.537 | 56.0 | 3.84 | 1.544 | 3.77 |
| 8 | | −0.7930 | (ASP) | 0.030 | | | | | | |
| 9 | Lens 4 | 0.7773 | (ASP) | 0.288 | Plastic | 1.638 | 20.4 | 4.29 | 1.660 | 4.11 |
| 10 | | 0.9290 | (ASP) | 0.300 | | | | | | |
| 11 | Filter | Plano | | 0.450 | Glass | 1.510 | 64.2 | — | 1.517 | — |
| 12 | | Plano | | 0.214 | | | | | | |
| 13 | Image | Plano | | — | | | | | | |
| | Surface | | | | | | | | | |

* Reference wavelength is 850.0 nm.
* The effective radius of the stop on Surface #3 is 0.320 mm.
* Reference wavelength is 587.6 nm (d-line).

TABLE 5B
Aspheric Coefficient

| Surface # | 1 | 2 | 4 | 5 |
|---|---|---|---|---|
| K= | −9.347010E+01 | −4.118840E+00 | −9.900000E+01 | −2.202220E+01 |
| A4= | 2.617294E+00 | 6.980912E+00 | −2.005364E−01 | −2.290021E+00 |
| A6= | −1.196400E+01 | 2.599421E+01 | −5.346458E+01 | 2.428287E+02 |
| A8= | 3.939079E+01 | −1.479062E+03 | 2.013067E+03 | −7.460425E+03 |
| A10= | −1.155926E+02 | 2.052034E+04 | −5.654692E+04 | 1.353166E+05 |
| A12= | 3.127634E+02 | −1.519062E+05 | 7.844930E+05 | −1.495208E+06 |
| A14= | −4.376867E+02 | 4.163222E+05 | −5.817111E+06 | 8.835444E+06 |
| A16= | | | 1.841799E+07 | −1.889304E+07 |
| Surface # | 7 | 8 | 9 | 10 |
| K= | −3.272370E+00 | −9.642780E+01 | −2.127290E−01 | −1.146190E+00 |
| A4= | 1.620385E+01 | −1.584180E+01 | −9.433258E−02 | 8.388673E−01 |
| A6= | −1.462425E+02 | 2.877513E+02 | −2.589597E+02 | 1.217019E+01 |
| A8= | −5.814485E+01 | −5.219434E+03 | 8.020648E+03 | −1.548431E+03 |
| A10= | 3.621584E+04 | 6.720554E+04 | −1.628347E+05 | 3.475209E+04 |
| A12= | −7.488732E+05 | −5.389780E+05 | 2.089581E+06 | −4.302509E+05 |
| A14= | 7.674653E+06 | 2.500138E+06 | −1.636072E+07 | 3.318149E+06 |
| A16= | −4.001272E+07 | −6.048628E+06 | 7.238462E+07 | −1.590947E+07 |
| A18= | 8.445236E+07 | 6.267889E+06 | −1.548619E+08 | 4.354772E+07 |
| A20= | | | 1.062754E+08 | −5.198684E+07 |

In the 5th embodiment, the equation of the aspheric surface profiles of the aforementioned lens elements is the same as the equation of the 1st embodiment. Also, the definitions of these parameters shown in the table below are the same as those stated in the 1st embodiment with corresponding values for the 5th embodiment, so an explanation in this regard will not be provided again.

Moreover, these parameters can be calculated from TABLE 5A and TABLE 5B and satisfy the conditions stated in TABLE 5C below.

TABLE 5C

| | | | |
|---|---|---|---|
| fd [mm] | 0.79 | (R3 − R4)/(R3 + R4) | 1.07 |
| Fno | 2.20 | (R6 − R8)/(R6 + R8) | −12.66 |
| FOVd [deg.] | 82.6 | (CT1 + CT4)/CT3 | 1.28 |
| TLd/EPDd | 6.72 | CT1/CT3 | 0.57 |
| TLd/SD | 3.09 | T12/CT1 | 0.95 |
| TD/BLd | 1.63 | T12/CT4 | 0.76 |
| BLd/SD | 1.18 | T12/(T23 + T34) | 2.56 |
| fd/TLd | 0.33 | T23/(T12 + T34) | 0.22 |
| fd/ΣAT | 2.57 | ΣCT/ΣAT | 3.87 |
| fd/CT4 | 2.73 | V2d/V4d | 1.0 |
| f1d/f2d | −1.28 | V4d | 20.4 |
| \|f2d/f4d\| | 0.21 | \|SAG1R1\|/Y1R1 | 0.15 |
| f1d/R2 | −1.85 | \|SAG1R2\|/CT1 | 0.56 |
| \|f1d/R4\| | 1.89 | Y4R2/CT4 | 1.41 |
| (R1 + R2)/(R1 − R2) | 1.01 | | |

### 6th Embodiment

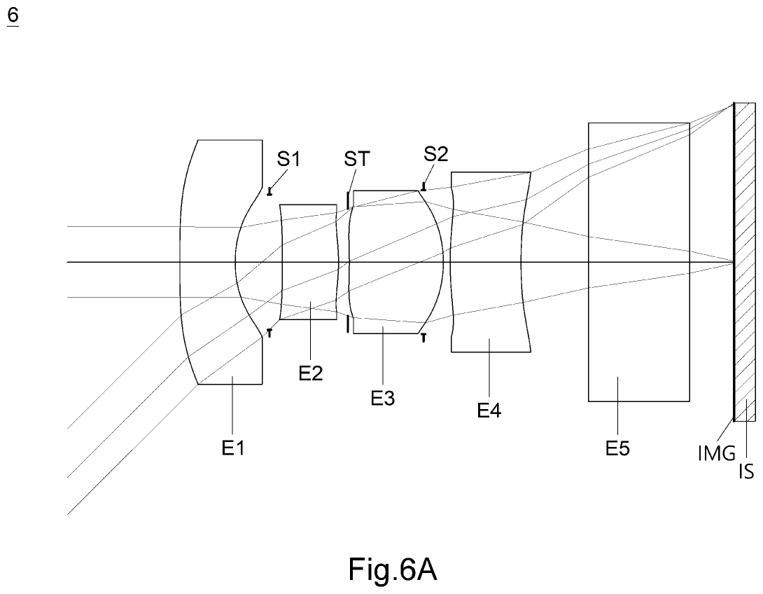

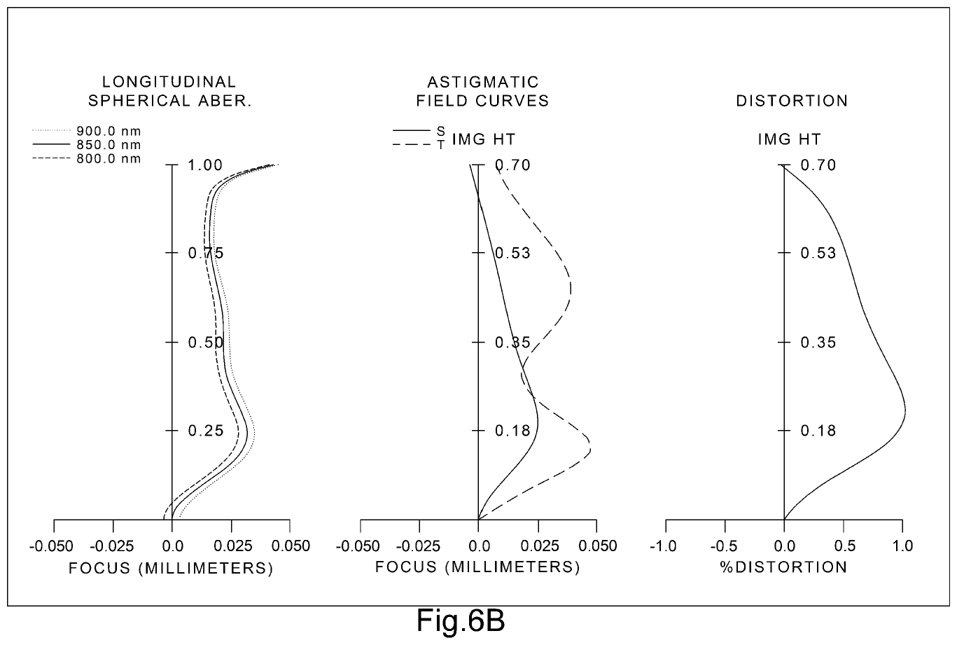

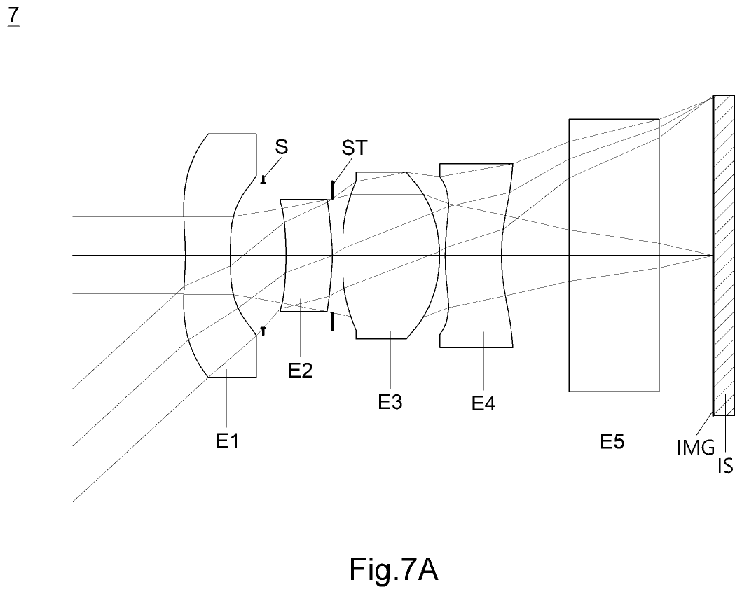

FIG. 6A is a schematic view of an imaging apparatus 6 according to the 6th embodiment of the present disclosure. FIG. 6B shows, in order from left to right, longitudinal spherical aberration curves, astigmatic field curves and a distortion curve of the imaging apparatus according to the 6th embodiment.

In FIG. 6A, the imaging apparatus 6 includes a photographing lens assembly of the present disclosure and an image sensor IS. The photographing lens assembly includes, in order from an object side to an image side along an optical path, a first lens element E1, a stop S1, a second lens element E2, an aperture stop ST, a third lens element E3, a stop S2, a fourth lens element E4, a filter E5, and an image surface IMG.

The first lens element E1 has negative refractive power and is made of plastic material. The first lens element E1 has an object-side surface being convex in a paraxial region thereof and having one inflection point, and an image-side surface being concave in a paraxial region thereof and having one inflection point. Both the object-side surface and the image-side surface are aspheric.

The second lens element E2 has positive refractive power and is made of plastic material. The second lens element E2 has an object-side surface being concave in a paraxial region thereof, and an image-side surface being convex in a paraxial region thereof and having one inflection point and one critical point. Both the object-side surface and the image-side surface are aspheric.

The third lens element E3 has positive refractive power and is made of plastic material. The third lens element E3 has an object-side surface being concave in a paraxial region thereof and having one inflection point and one critical point, and an image-side surface being convex in a paraxial region thereof and having one inflection point. Both the object-side surface and the image-side surface are aspheric.

The fourth lens element E4 has positive refractive power and is made of plastic material. The fourth lens element E4 has an object-side surface being convex in a paraxial region thereof and having one inflection point and one critical point, and an image-side surface being concave in a paraxial region thereof and having one inflection point. Both the object-side surface and the image-side surface are aspheric.

The filter E5 is disposed between the fourth lens element E4 and the image surface IMG. The filter E5 is made of glass material and does not affect the focal length of the photographing lens assembly. The image sensor IS is disposed on or near the image surface IMG.

The detailed optical data of the 6th embodiment are shown in TABLE 6A, and the aspheric surface data are shown in TABLE 6B.

TABLE 6A
(6th Embodiment)
f = 0.69 mm, Fno = 2.20, HFOV = 45.0 deg./fd = 0.67 mm, TLd = 2.432 mm, BLd = 0.917 mm.

| | | | | | | | | | | Focal |
|---|---|---|---|---|---|---|---|---|---|---|
| Surface | | | | | | | Abbe | Focal | Index | Length |
| # | | Curvature Radius | | Thickness | Material | Index | # | Length | (d-line) | (d-line) |
| 0 | Object | Plano | | 600.000 | | | | | | |
| 1 | Lens 1 | 100.0000 | (ASP) | 0.246 | Plastic | 1.537 | 56.1 | −0.96 | 1.545 | −0.94 |
| 2 | | 0.5107 | (ASP) | 0.152 | | | | | | |
| 3 | Stop | Plano | | 0.057 | | | | | | |
| 4 | Lens 2 | −55.9339 | (ASP) | 0.250 | Plastic | 1.638 | 20.4 | 1.44 | 1.660 | 1.39 |
| 5 | | −0.9054 | (ASP) | 0.042 | | | | | | |
| 6 | Ape. | Plano | | 0.006 | | | | | | |
| | Stop | | | | | | | | | |
| 7 | Lens 3 | −2.1554 | (ASP) | 0.417 | Plastic | 1.537 | 56.0 | 1.18 | 1.544 | 1.17 |
| 8 | | −0.5237 | (ASP) | −0.088 | | | | | | |
| 9 | Stop | Plano | | 0.118 | | | | | | |
| 10 | Lens 4 | 1.3156 | (ASP) | 0.315 | Plastic | 1.638 | 20.4 | 5.47 | 1.660 | 5.26 |
| 11 | | 1.9159 | (ASP) | 0.300 | | | | | | |
| 12 | Filter | Plano | | 0.450 | Glass | 1.510 | 64.2 | — | 1.517 | — |
| 13 | | Plano | | 0.197 | | | | | | |
| 14 | Image | Plano | | — | | | | | | |
| | Surface | | | | | | | | | |

* Reference wavelength is 850.0 nm.
* The effective radius of the stop on Surface #3 is 0.300 mm.
* The effective radius of the stop on Surface #9 is 0.320 mm.
* Reference wavelength is 587.6 nm (d-line).

TABLE 6B
Aspheric Coefficient

| Surface # | 1 | 2 | 4 | 5 |
|---|---|---|---|---|
| K= | −9.347010E+01 | −7.117780E+00 | 9.900000E+01 | −2.443400E+01 |
| A4= | 2.061211E+00 | 7.569159E+00 | −3.620449E+00 | −1.610497E−01 |
| A6= | −8.489240E+00 | 2.658708E+01 | 8.160908E+01 | 3.116413E+02 |
| A8= | 2.934519E+01 | −2.065103E+03 | −4.164122E+03 | −1.447269E+04 |
| A10= | −6.806122E+01 | 3.337646E+04 | 1.288572E+05 | 5.123632E+05 |
| A12= | 9.839649E+01 | −2.610865E+05 | −2.173753E+06 | −1.033418E+07 |
| A14= | −8.731750E+01 | 7.457855E+05 | 1.831528E+07 | 1.083578E+08 |
| A16= | | | −6.108525E+07 | −4.482009E+08 |
| Surface # | 7 | 8 | 10 | 11 |
| K= | 2.543250E+01 | −5.659850E+01 | 7.477370E+00 | −1.312660E+01 |
| A4= | 7.183891E+00 | −4.137725E+01 | −4.930306E+00 | 1.230668E+00 |
| A6= | 2.583930E+02 | 1.999213E+03 | 2.055476E+02 | 2.790545E+01 |
| A8= | −1.797007E+04 | −7.643893E+04 | −9.077704E+03 | −1.275993E+03 |
| A10= | 7.800500E+05 | 2.003952E+06 | 2.393169E+05 | 2.416500E+04 |
| A12= | −2.132386E+07 | −3.528632E+07 | −4.142948E+06 | −2.863258E+05 |
| A14= | 3.620300E+08 | 4.086772E+08 | 4.675813E+07 | 2.172795E+06 |
| A16= | −3.700411E+09 | −2.970644E+09 | −3.283300E+08 | −1.015260E+07 |
| A18= | 2.082831E+10 | 1.222636E+10 | 1.285891E+09 | 2.641566E+07 |
| A20= | −4.955670E+10 | −2.160202E+10 | −2.120304E+09 | −2.911734E+07 |

In the 6th embodiment, the equation of the aspheric surface profiles of the aforementioned lens elements is the same as the equation of the 1st embodiment. Also, the definitions of these parameters shown in the table below are the same as those stated in the 1st embodiment with corresponding values for the 6th embodiment, so an explanation in this regard will not be provided again.

Moreover, these parameters can be calculated from TABLE 6A and TABLE 6B and satisfy the conditions stated in TABLE 6C below.

TABLE 6C

| | | | |
|---|---|---|---|
| fd [mm] | 0.67 | (R3 − R4)/(R3 + R4) | 0.97 |
| Fno | 2.20 | (R6 − R8)/(R6 + R8) | −1.75 |
| FOVd [deg.] | 91.9 | (CT1 + CT4)/CT3 | 1.35 |
| TLd/EPDd | 7.99 | CT1/CT3 | 0.59 |
| TLd/SD | 3.17 | T12/CT1 | 0.85 |
| TD/BLd | 1.65 | T12/CT4 | 0.66 |
| BLd/SD | 1.19 | T12/(T23 + T34) | 2.68 |
| fd/TLd | 0.28 | T23/(T12 + T34) | 0.20 |
| fd/ΣAT | 2.33 | ΣCT/ΣAT | 4.28 |
| fd/CT4 | 2.13 | V2d/V4d | 1.0 |
| f1d/f2d | −0.68 | V4d | 20.4 |
| \|f2d/f4d\| | 0.26 | \|SAG1R1\|/Y1R1 | 0.15 |
| f1d/R2 | −1.85 | \|SAG1R2\|/CT1 | 0.49 |
| \|f1d/R4\| | 1.04 | Y4R2/CT4 | 1.27 |
| (R1 + R2)/(R1 − R2) | 1.01 | | |

### 7th Embodiment

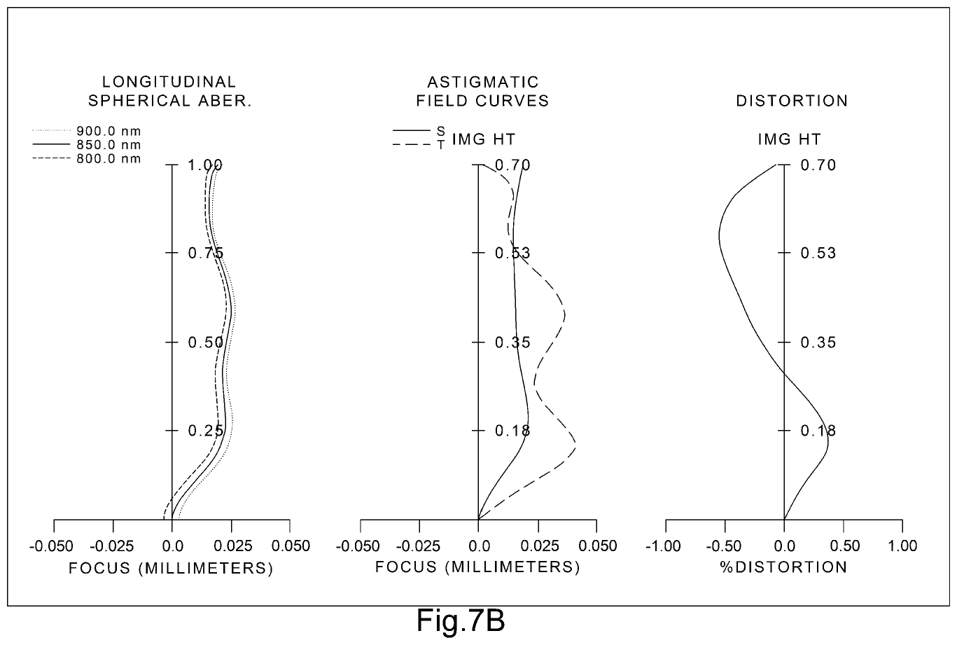

FIG. 7A is a schematic view of an imaging apparatus 7 according to the 7th embodiment of the present disclosure. FIG. 7B shows, in order from left to right, longitudinal spherical aberration curves, astigmatic field curves and a distortion curve of the imaging apparatus according to the 7th embodiment.

In FIG. 7A, the imaging apparatus 7 includes a photographing lens assembly of the present disclosure and an image sensor IS. The photographing lens assembly includes, in order from an object side to an image side along an optical path, a first lens element E1, a stop S, a second lens element E2, an aperture stop ST, a third lens element E3, a fourth lens element E4, a filter E5, and an image surface IMG.

The first lens element E1 has negative refractive power and is made of glass material. The first lens element E1 has an object-side surface being concave in a paraxial region thereof and having one inflection point and one critical point, and an image-side surface being concave in a paraxial region thereof and having one inflection point. Both the object-side surface and the image-side surface are aspheric.

The second lens element E2 has positive refractive power and is made of plastic material. The second lens element E2 has an object-side surface being concave in a paraxial region thereof, and an image-side surface being convex in a paraxial region thereof and having two inflection points. Both the object-side surface and the image-side surface are aspheric.

The third lens element E3 has positive refractive power and is made of plastic material. The third lens element E3 has an object-side surface being concave in a paraxial region thereof and having one inflection point and one critical point, and an image-side surface being convex in a paraxial region thereof and having one inflection point. Both the object-side surface and the image-side surface are aspheric.

The fourth lens element E4 has negative refractive power and is made of plastic material. The fourth lens element E4 has an object-side surface being convex in a paraxial region thereof and having one inflection point and one critical point, and an image-side surface being concave in a paraxial region thereof and having two inflection points. Both the object-side surface and the image-side surface are aspheric.

The filter E5 is disposed between the fourth lens element E4 and the image surface IMG. The filter E5 is made of glass material and does not affect the focal length of the photographing lens assembly. The image sensor IS is disposed on or near the image surface IMG.

The detailed optical data of the 7th embodiment are shown in TABLE 7A. and the aspheric surface data are shown in TABLE 7B.

TABLE 7A
(7th Embodiment)
f = 0.75 mm, Fno = 2.20, HFOV = 42.6 deg./fd = 0.73 mm, TLd = 2.314 mm, BLd = 0.911 mm.

| | | | | | | | | | | Focal |
|---|---|---|---|---|---|---|---|---|---|---|
| Surface | | | | | | | Abbe | Focal | Index | Length |
| # | | Curvature Radius | | Thickness | Material | Index | # | Length | (d-line) | (d-line) |
| 0 | Object | Plano | | 600.000 | | | | | | |
| 1 | Lens 1 | −1.2533 | (ASP) | 0.200 | Glass | 1.581 | 61.2 | −1.44 | 1.589 | −1.42 |
| 2 | | 2.6641 | (ASP) | 0.146 | | | | | | |
| 3 | Stop | Plano | | 0.101 | | | | | | |
| 4 | Lens 2 | −1.5622 | (ASP) | 0.206 | Plastic | 1.645 | 19.5 | 1.73 | 1.669 | 1.67 |
| 5 | | −0.6856 | (ASP) | 0.000 | | | | | | |
| 6 | Ape. | Plano | | 0.047 | | | | | | |
| | Stop | | | | | | | | | |
| 7 | Lens 3 | −4.6940 | (ASP) | 0.428 | Plastic | 1.537 | 56.0 | 1.14 | 1.544 | 1.12 |
| 8 | | −0.5586 | (ASP) | 0.025 | | | | | | |
| 9 | Lens 4 | 1.0577 | (ASP) | 0.250 | Plastic | 1.669 | 16.3 | −13.73 | 1.697 | −13.51 |
| 10 | | 0.8586 | (ASP) | 0.300 | | | | | | |
| 11 | Filter | Plano | | 0.400 | Glass | 1.510 | 64.2 | — | 1.517 | — |
| 12 | | Plano | | 0.240 | | | | | | |
| 13 | Image | Plano | | — | | | | | | |
| | Surface | | | | | | | | | |

* Reference wavelength is 850.0 nm.
* The effective radius of the stop on Surface #3 is 0.322 mm.
* Reference wavelength is 587.6 nm (d-line).

TABLE 7B
Aspheric Coefficient

| Surface # | 1 | 2 | 4 | 5 |
|---|---|---|---|---|
| K= | −3.198480E+01 | 3.711340E+01 | 2.245810E+01 | −3.571100E+01 |
| A4= | 5.069603E+00 | 9.862617E+00 | 2.307230E+00 | 2.801958E+00 |
| A6= | −3.328467E+01 | −2.857051E+01 | −9.003393E+01 | 2.141579E+02 |
| A8= | 1.926854E+02 | −3.830405E+02 | 3.455903E+03 | −1.324313E+04 |
| A10= | −7.537211E+02 | 9.132417E+03 | −1.471151E+05 | 3.063309E+05 |
| A12= | 1.712217E+03 | −7.702139E+04 | 2.943043E+06 | −3.836641E+06 |
| A14= | −1.652600E+03 | 1.984081E+05 | −2.882080E+07 | 2.539538E+07 |
| A16= | | | 1.139764E+08 | −6.692224E+07 |
| Surface # | 7 | 8 | 9 | 10 |
| K= | 8.303580E+01 | −4.943740E+01 | 1.315810E+00 | −3.274450E+00 |
| A4= | 2.256687E+01 | −2.325168E+01 | 1.264625E+00 | 4.199554E−01 |
| A6= | −3.726510E+02 | 7.505343E+02 | −3.553186E+02 | −5.528622E+01 |
| A8= | 2.993989E+03 | −2.102157E+04 | 1.475935E+04 | 1.576328E+03 |
| A10= | 1.301296E+04 | 4.072302E+05 | −4.345346E+05 | −4.399846E+04 |
| A12= | −7.095506E+05 | −5.248134E+06 | 8.476424E+06 | 8.228366E+05 |
| A14= | 9.718019E+06 | 4.395665E+07 | −1.090739E+08 | −9.636524E+06 |
| A16= | −7.315755E+07 | −2.289430E+08 | 9.132702E+08 | 7.066817E+07 |
| A18= | 3.072080E+08 | 6.709190E+08 | −4.783035E+09 | −3.158033E+08 |
| A20= | −5.620874E+08 | −8.402868E+08 | 1.423352E+10 | 7.861363E+08 |
| A22= | | | −1.835175E+10 | −8.347743E+08 |

In the 7th embodiment, the equation of the aspheric surface profiles of the aforementioned lens elements is the same as the equation of the 1st embodiment. Also, the definitions of these parameters shown in the table below are the same as those stated in the 1st embodiment with corresponding values for the 7th embodiment, so an explanation in this regard will not be provided again.

Moreover, these parameters can be calculated from TABLE 7A and TABLE 7B and satisfy the conditions stated in TABLE 7C below.

TABLE 7C

| | | | |
|---|---|---|---|
| fd [mm] | 0.73 | (R3 − R4)/(R3 + R4) | 0.39 |
| Fno | 2.20 | (R6 − R8)/(R6 + R8) | −4.72 |
| FOVd [deg.] | 86.8 | (CT1 + CT4)/CT3 | 1.05 |
| TLd/EPDd | 6.98 | CT1/CT3 | 0.47 |
| TLd/SD | 3.08 | T12/CT1 | 1.24 |
| TD/BLd | 1.54 | T12/CT4 | 0.99 |
| BLd/SD | 1.21 | T12/(T23 + T34) | 3.43 |
| fd/TLd | 0.32 | T23/(T12 + T34) | 0.17 |
| fd/ΣAT | 2.29 | ΣCT/ΣAT | 3.40 |
| fd/CT4 | 2.92 | V2d/V4d | 1.2 |
| f1d/f2d | −0.85 | V4d | 16.3 |
| \|f2d/f4d\| | 0.12 | \|SAG1R1\|/Y1R1 | 0.19 |
| f1d/R2 | −0.53 | \|SAG1R2\|/CT1 | 0.58 |
| \|f1d/R4\| | 2.07 | Y4R2/CT4 | 1.63 |
| (R1 + R2)/(R1 − R2) | −0.36 | | |

### 8th Embodiment

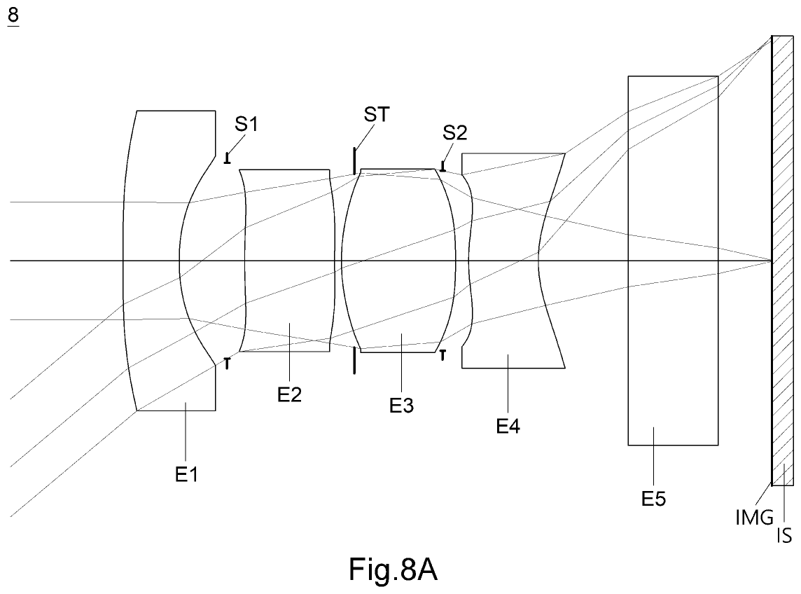

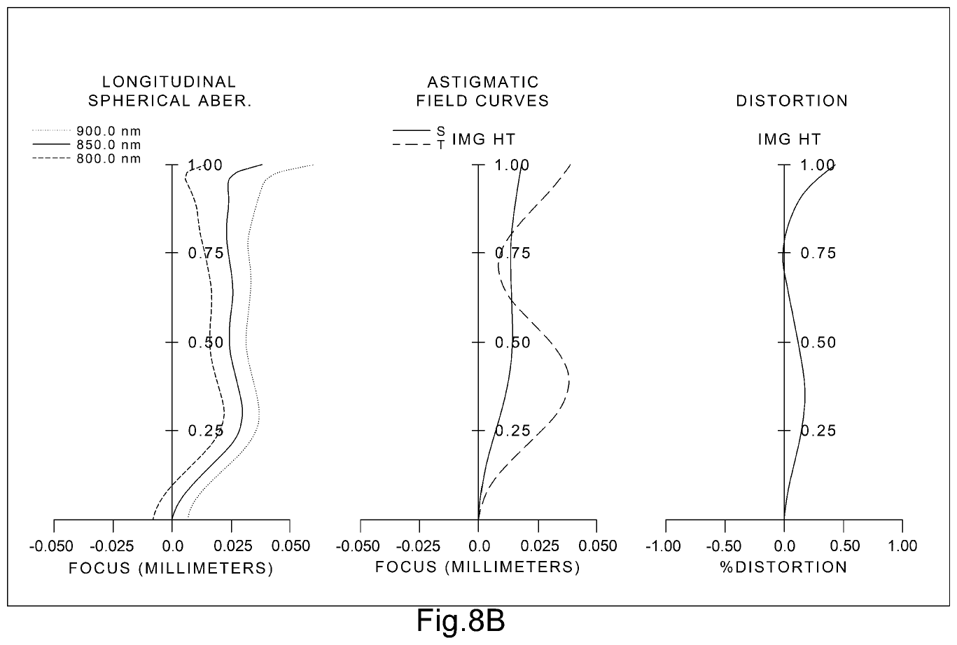

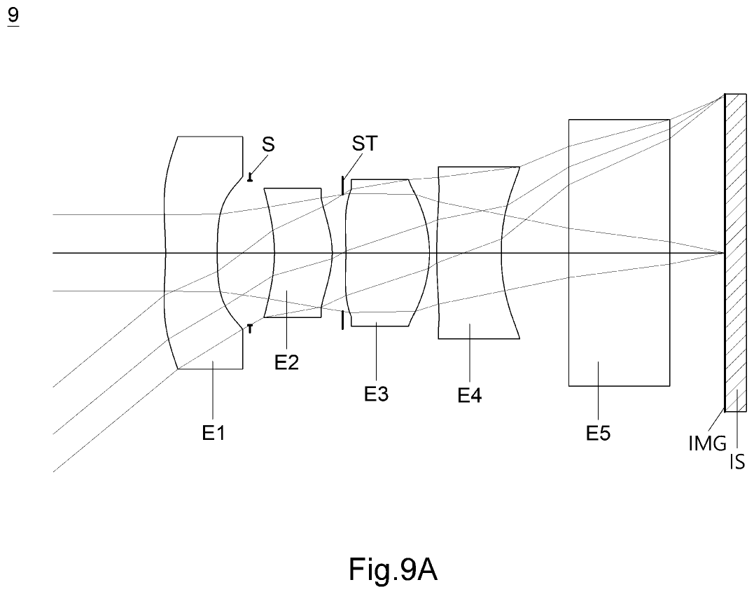

FIG. 8A is a schematic view of an imaging apparatus 8 according to the 8th embodiment of the present disclosure. FIG. 8B shows, in order from left to right, longitudinal spherical aberration curves, astigmatic field curves and a distortion curve of the imaging apparatus according to the 8th embodiment.

In FIG. 8A, the imaging apparatus 8 includes a photographing lens assembly of the present disclosure and an image sensor IS. The photographing lens assembly includes, in order from an object side to an image side along an optical path, a first lens element E1, a stop S1, a second lens element E2, an aperture stop ST, a third lens element E3, a stop S2, a fourth lens element E4, a filter E5, and an image surface IMG.

The first lens element E1 has negative refractive power and is made of plastic material. The first lens element E1 has an object-side surface being convex in a paraxial region thereof, and an image-side surface being concave in a paraxial region thereof and having one inflection point. Both the object-side surface and the image-side surface are aspheric.

The second lens element E2 has positive refractive power and is made of plastic material. The second lens element E2 has an object-side surface being convex in a paraxial region thereof and having one inflection point and one critical point, and an image-side surface being concave in a paraxial region thereof and having two inflection points and one critical point. Both the object-side surface and the image-side surface are aspheric.

The third lens element E3 has positive refractive power and is made of plastic material. The third lens element E3 has an object-side surface being convex in a paraxial region thereof, and an image-side surface being convex in a paraxial region thereof. Both the object-side surface and the image-side surface are aspheric.

The fourth lens element E4 has negative refractive power and is made of plastic material. The fourth lens element E4 has an object-side surface being convex in a paraxial region thereof and having one inflection point and one critical point, and an image-side surface being concave in a paraxial region thereof and having one inflection point. Both the object-side surface and the image-side surface are aspheric.

The filter E5 is disposed between the fourth lens element E4 and the image surface IMG. The filter E5 is made of glass material and does not affect the focal length of the photographing lens assembly. The image sensor IS is disposed on or near the image surface IMG.

The detailed optical data of the 8th embodiment are shown in TABLE 8A, and the aspheric surface data are shown in TABLE 8B.

TABLE 8A
(8th Embodiment)
f = 1.15 mm, Fno = 2.20, HFOV = 40.0 deg./fd = 1.08 mm, TLd = 2.815 mm, BLd = 0.970 mm.

| | | | | | | | | | | Focal |
|---|---|---|---|---|---|---|---|---|---|---|
| Surface | | | | | | | Abbe | Focal | Index | Length |
| # | | Curvature Radius | | Thickness | Material | Index | # | Length | (d-line) | (d-line) |
| 0 | Object | Plano | | 600.000 | | | | | | |
| 1 | Lens 1 | 25.7074 | (ASP) | 0.250 | Plastic | 1.537 | 56.1 | −1.63 | 1.545 | −1.61 |
| 2 | | 0.8437 | (ASP) | 0.213 | | | | | | |
| 3 | Stop | Plano | | 0.078 | | | | | | |
| 4 | Lens 2 | 2.7732 | (ASP) | 0.400 | Plastic | 1.527 | 56.0 | 15.72 | 1.534 | 15.49 |
| 5 | | 3.9618 | (ASP) | 0.088 | | | | | | |
| 6 | Ape. | Plano | | −0.058 | | | | | | |
| | Stop | | | | | | | | | |
| 7 | Lens 3 | 0.7700 | (ASP) | 0.506 | Plastic | 1.638 | 20.4 | 0.99 | 1.660 | 0.96 |
| 8 | | −2.6669 | (ASP) | −0.057 | | | | | | |
| 9 | Stop | Plano | | 0.115 | | | | | | |
| 10 | Lens 4 | 0.7259 | (ASP) | 0.310 | Plastic | 1.638 | 20.4 | −12.92 | 1.660 | −13.17 |
| 11 | | 0.5562 | (ASP) | 0.400 | | | | | | |
| 12 | Filter | Plano | | 0.400 | Glass | 1.510 | 64.2 | — | 1.517 | — |
| 13 | | Plano | | 0.239 | | | | | | |
| 14 | Image | Plano | | — | | | | | | |
| | Surface | | | | | | | | | |

* Reference wavelength is 850.0 nm.
* The effective radius of the stop on Surface #3 is 0.435 mm.
* The effective radius of the stop on Surface #9 is 0.400 mm.
* Reference wavelength is 587.6 nm (d-line).

TABLE 8B
Aspheric Coefficient

| Surface # | 1 | 2 | 4 | 5 |
|---|---|---|---|---|
| K= | −1.992190E+00 | −1.226580E+01 | 2.436030E+01 | −3.952960E+01 |
| A4= | 6.670519E−01 | 3.481008E+00 | −1.513101E+00 | −5.170920E+00 |
| A6= | −1.574096E+00 | −1.295122E+01 | −3.933046E+00 | 5.301937E+01 |
| A8= | 2.074796E+00 | 4.230494E+01 | −2.825786E+01 | −5.578835E+02 |
| A10= | −1.228737E+00 | −9.640853E+01 | 5.281111E+02 | 4.703103E+03 |
| A12= | | | −5.441800E+03 | −2.444520E+04 |
| A14= | | | 2.718310E+04 | 6.803573E+04 |
| A16= | | | −4.793257E+04 | −6.478654E+04 |
| Surface # | 7 | 8 | 10 | 11 |
| K= | −2.892980E+01 | −2.396140E−01 | −1.218860E+01 | −1.212730E+00 |
| A4= | 3.999140E+00 | −6.232679E+00 | −6.164224E+00 | −1.903396E+00 |
| A6= | −7.078446E+01 | 7.214537E+01 | 1.202515E+02 | −2.848587E+00 |
| A8= | 1.034764E+03 | −7.628005E+02 | −4.066303E+03 | −6.089878E+00 |
| A10= | −9.428749E+03 | 6.084780E+03 | 8.587331E+04 | 1.198261E+03 |
| A12= | 5.208365E+04 | −3.219609E+04 | −1.146930E+06 | −1.521400E+04 |
| A14= | −1.584201E+05 | 9.927298E+04 | 9.576532E+06 | 9.623784E+04 |
| A16= | 2.016788E+05 | −1.343009E+05 | −4.820321E+07 | −3.438998E+05 |
| A18= | | | 1.326178E+08 | 6.608546E+05 |
| A20= | | | −1.516739E+08 | −5.306968E+05 |

In the 8th embodiment, the equation of the aspheric surface profiles of the aforementioned lens elements is the same as the equation of the 1st embodiment. Also, the definitions of these parameters shown in the table below are the same as those stated in the 1st embodiment with corresponding values for the 8th embodiment, so an explanation in this regard will not be provided again.

Moreover, these parameters can be calculated from TABLE 8A and TABLE 8B and satisfy the conditions stated in TABLE 8C below.

TABLE 8C

| | | | |
|---|---|---|---|
| fd [mm] | 1.08 | (R3 − R4)/(R3 + R4) | −0.18 |
| Fno | 2.20 | (R6 − R8)/(R6 + R8) | 1.53 |
| FOVd [deg.] | 83.5 | (CT1 + CT4)/CT3 | 1.11 |
| TLd/EPDd | 5.73 | CT1/CT3 | 0.49 |
| TLd/SD | 3.45 | T12/CT1 | 1.16 |
| TD/BLd | 1.90 | T12/CT4 | 0.94 |
| BLd/SD | 1.19 | T12/(T23 + T34) | 3.31 |
| fd/TLd | 0.38 | T23/(T12 + T34) | 0.09 |
| fd/ΣAT | 2.85 | ΣCT/ΣAT | 3.87 |
| fd/CT4 | 3.49 | V2d/V4d | 2.7 |
| f1d/f2d | −0.10 | V4d | 20.4 |
| \|f2d/f4d\| | 1.18 | \|SAG1R1\|/Y1R1 | 0.09 |
| f1d/R2 | −1.90 | \|SAG1R2\|/CT1 | 0.65 |
| \|f1d/R4\| | 0.41 | Y4R2/CT4 | 1.52 |
| (R1 + R2)/(R1 − R2) | 1.07 | | |

### 9th Embodiment

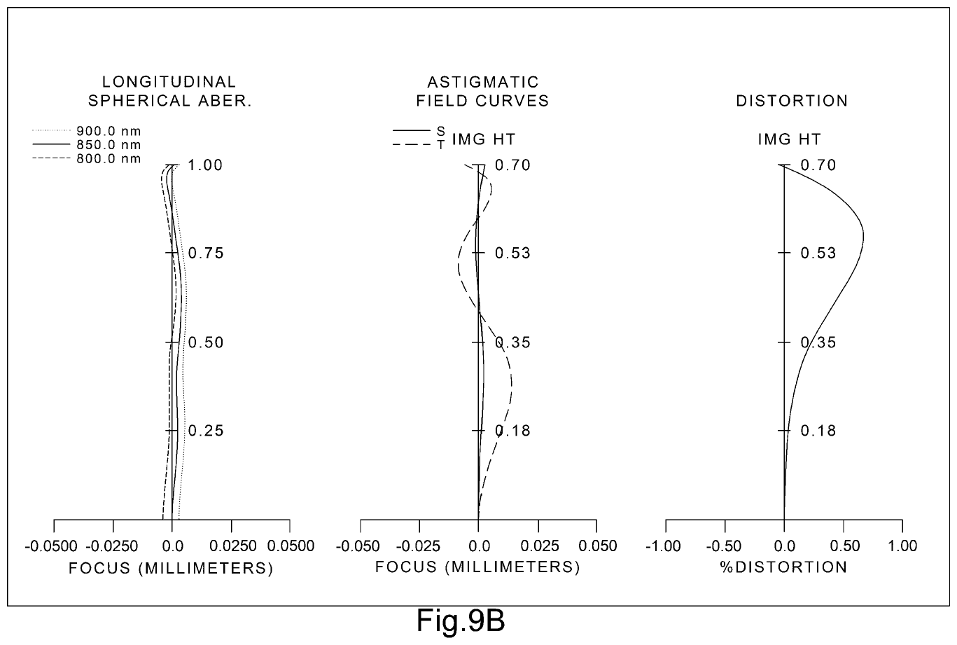

FIG. 9A is a schematic view of an imaging apparatus 9 according to the 9th embodiment of the present disclosure. FIG. 9B shows, in order from left to right, longitudinal spherical aberration curves, astigmatic field curves and a distortion curve of the imaging apparatus according to the 9th embodiment.

In FIG. 9A, the imaging apparatus 9 includes a photographing lens assembly of the present disclosure and an image sensor IS. The photographing lens assembly includes, in order from an object side to an image side along an optical path, a first lens element E1, a stop S, a second lens element E2, an aperture stop ST, a third lens element E3, a fourth lens element E4, a filter E5, and an image surface IMG.

The first lens element E1 has negative refractive power and is made of plastic material. The first lens element E1 has an object-side surface being concave in a paraxial region thereof and having two inflection points and one critical point, and an image-side surface being concave in a paraxial region thereof and having one inflection point. Both the object-side surface and the image-side surface are aspheric.

The second lens element E2 has positive refractive power and is made of plastic material. The second lens element E2 has an object-side surface being concave in a paraxial region thereof, and an image-side surface being convex in a paraxial region thereof and having one inflection point. Both the object-side surface and the image-side surface are aspheric.

The third lens element E3 has positive refractive power and is made of plastic material. The third lens element E3 has an object-side surface being concave in a paraxial region thereof and having one inflection point and one critical point, and an image-side surface being convex in a paraxial region thereof and having one inflection point. Both the object-side surface and the image-side surface are aspheric.

The fourth lens element E4 has negative refractive power and is made of plastic material. The fourth lens element E4 has an object-side surface being convex in a paraxial region thereof and having one inflection point and one critical point, and an image-side surface being concave in a paraxial region thereof and having one inflection point. Both the object-side surface and the image-side surface are aspheric.

The filter E5 is disposed between the fourth lens element E4 and the image surface IMG. The filter E5 is made of glass material and does not affect the focal length of the photographing lens assembly. The image sensor IS is disposed on or near the image surface IMG.

The detailed optical data of the 9th embodiment are shown in TABLE 9A. and the aspheric surface data are shown in TABLE 9B.

TABLE 9A
(9th Embodiment)
f = 0.85 mm, Fno = 2.50, HFOV = 39.6 deg./fd = 0.82 mm, TLd = 2.455 mm, BLd = 0.964 mm.

| | | | | | | | | | | Focal |
|---|---|---|---|---|---|---|---|---|---|---|
| Surface | | | | | | | Abbe | Focal | Index | Length |
| # | | Curvature Radius | | Thickness | Material | Index | # | Length | (d-line) | (d-line) |
| 0 | Object | Plano | | 600.000 | | | | | | |
| 1 | Lens 1 | −1.5152 | (ASP) | 0.230 | Plastic | 1.527 | 56.0 | −1.77 | 1.534 | −1.75 |
| 2 | | 2.5614 | (ASP) | 0.145 | | | | | | |
| 3 | Stop | Plano | | 0.109 | | | | | | |
| 4 | Lens 2 | −0.7012 | (ASP) | 0.257 | Plastic | 1.596 | 25.6 | 1.05 | 1.614 | 1.01 |
| 5 | | −0.3754 | (ASP) | 0.046 | | | | | | |
| 6 | Ape. | Plano | | 0.015 | | | | | | |
| | Stop | | | | | | | | | |
| 7 | Lens 3 | −1.4131 | (ASP) | 0.370 | Plastic | 1.537 | 56.0 | 1.41 | 1.544 | 1.39 |
| 8 | | −0.5385 | (ASP) | 0.032 | | | | | | |
| 9 | Lens 4 | 2.6257 | (ASP) | 0.287 | Plastic | 1.654 | 18.2 | −2.36 | 1.680 | −2.27 |
| 10 | | 0.9299 | (ASP) | 0.300 | | | | | | |
| 11 | Filter | Plano | | 0.450 | Glass | 1.510 | 64.2 | — | 1.517 | — |
| 12 | | Plano | | 0.244 | | | | | | |
| 13 | Image | Plano | | — | | | | | | |
| | Surface | | | | | | | | | |

* Reference wavelength is 850.0 nm.
* The effective radius of the stop on Surface #3 is 0.321 mm.
* Reference wavelength is 587.6 nm (d-line).

TABLE 9B
Aspheric Coefficient

| Surface # | 1 | 2 | 4 | 5 |
|---|---|---|---|---|
| K = | −4.398090E+01 | 4.135190E+01 | −2.489550E+01 | −7.740980E+00 |
| A4 = | 3.716191E+00 | 8.453134E+00 | −6.247063E+00 | −1.906970E+00 |
| A6 = | −1.882219E+01 | −1.188487E+01 | 1.660670E+02 | 1.258508E+02 |
| A8 = | 9.278725E+01 | −3.185168E+02 | −2.999746E+03 | −3.080450E+03 |
| A10= | −3.472497E+02 | 9.721693E+03 | 3.751733E+04 | 5.739337E+04 |
| A12= | 7.113422E+02 | −9.187154E+04 | −2.868720E+05 | −6.236097E+05 |
| A14= | −6.124322E+02 | 2.332444E+05 | 1.043117E+06 | 3.395987E+06 |
| A16= | | | −1.061400E+06 | −5.194681E+06 |
| Surface # | 7 | 8 | 9 | 10 |
| K = | 3.141830E+00 | −1.686080E+01 | 5.134530E+01 | 2.102600E+00 |
| A4 = | 1.802072E+01 | −9.856041E+00 | 1.038783E+00 | 1.044976E+00 |
| A6 = | −3.708402E+02 | 1.416140E+02 | −5.321282E+01 | 5.360212E+00 |
| A8 = | 8.284780E+03 | −2.541496E+03 | −1.759224E+03 | −9.135327E+02 |
| A10= | −1.427139E+05 | 4.256661E+04 | 1.253162E+05 | 2.324096E+04 |
| A12= | 1.703554E+06 | −4.341774E+05 | −3.301883E+06 | −3.153976E+05 |
| A14= | −1.263463E+07 | 2.122629E+06 | 4.865379E+07 | 2.393881E+06 |
| A16= | 5.150635E+07 | −1.171635E+06 | −4.217628E+08 | −9.777481E+06 |
| A18= | −8.881073E+07 | −1.676252E+07 | 2.012203E+09 | 1.819966E+07 |
| A20= | | | −4.085222E+09 | −8.309039E+06 |

In the 9th embodiment, the equation of the aspheric surface profiles of the aforementioned lens elements is the same as the equation of the 1st embodiment. Also, the definitions of these parameters shown in the table below are the same as those stated in the 1st embodiment with corresponding values for the 9th embodiment, so an explanation in this regard will not be provided again.

Moreover, these parameters can be calculated from TABLE 9A and TABLE 9B and satisfy the conditions stated in TABLE 9C below.

TABLE 9C

| | | | |
|---|---|---|---|
| fd [mm] | 0.82 | (R3 − R4)/(R3 + R4) | 0.30 |
| Fno | 2.50 | (R6 − R8)/(R6 + R8) | −3.75 |
| FOVd [deg.] | 81.0 | (CT1 + CT4)/CT3 | 1.40 |
| TLd/EPDd | 7.44 | CT1/CT3 | 0.62 |
| TLd/SD | 3.49 | T12/CT1 | 1.10 |
| TD/BLd | 1.55 | T12/CT4 | 0.89 |
| BLd/SD | 1.37 | T12/(T23 + T34) | 2.73 |
| fd/TLd | 0.34 | T23/(T12 + T34) | 0.21 |
| fd/ΣAT | 2.38 | ΣCT/ΣAT | 3.30 |
| fd/CT4 | 2.87 | V2d/V4d | 1.4 |
| f1d/f2d | −1.73 | V4d | 18.2 |
| \|f2d/f4d\| | 0.45 | \|SAG1R1\|/Y1R1 | 0.11 |
| f1d/R2 | −0.68 | \|SAG1R2\|/CT1 | 0.49 |
| \|f1d/R4\| | 4.66 | Y4R2/CT4 | 1.31 |
| (R1 + R2)/(R1 − R2) | −0.26 | | |

### 10th Embodiment

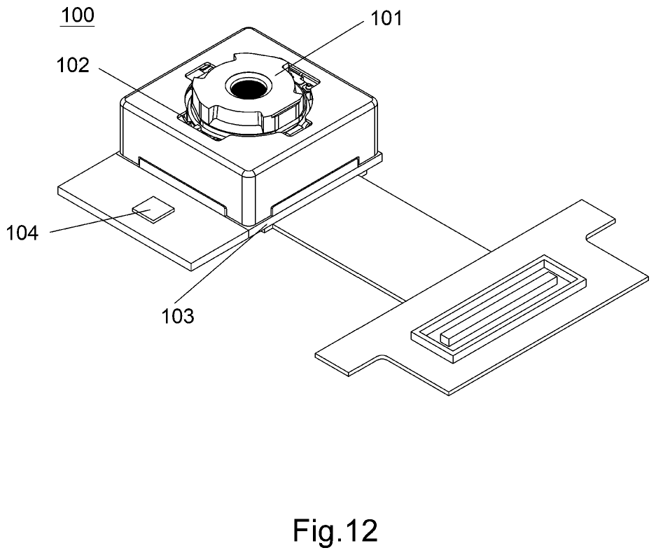

Please refer to FIG. 12. FIG. 12 is a 3-dimensional schematic view of an imaging apparatus 100 according to the 10th embodiment of the present disclosure. In the present embodiment, the imaging apparatus 100 is a camera module. The imaging apparatus 100 includes a photographing optical lens system 101, a driving device 102, and an image sensor 103. The photographing optical lens system 101 includes the photographing lens assembly of the 1st embodiment described above and a lens barrel (not otherwise herein labeled) for carrying the photographing lens assembly. The imaging apparatus 100 obtains an image from light convergence in the photographing optical lens system 101, and focusing by the driving device 102 so as to form the image on the image sensor 103 (the image sensor IS in the 1st embodiment), and outputs the image data thereafter.

The driving device 102 may be an auto-focus module that can be driven by a voice coil motor (VCM), a micro electro-mechanical system (MEMS), a piezoelectric system, shape memory alloys or other driving systems. The driving device 102 allows the photographing optical lens system 101 to obtain a better imaging position so as to obtain a clear image at different object distances.

The imaging apparatus 100 may be equipped with an image sensor 103 (e.g., CMOS, CCD) with high sensitivity and low noise on the image surface to provide accurate and satisfactory image quality from the photographing optical lens system 101.

In addition, the imaging apparatus 100 may further include an image stabilizer 104, which may be a motion sensing element such as an accelerometer, a gyro sensor or a Hall Effect sensor. The image stabilizer 104 in the 10th embodiment is a gyro sensor but is not limited thereto. By adjusting the photographing optical lens system 101 in different axial directions to provide compensation for image blurs due to motion during exposures, the image quality under dynamic and low-light circumstances can be further improved, and enhanced image compensation functions such as optical image stabilization (OIS) or electronic image stabilization (EIS) can also be provided.

The imaging apparatus 100 of the present disclosure is not limited to being applied to smartphones. The imaging apparatus 100 may be used in focus adjusting systems depending on the needs, while it features excellent aberration correction and provides satisfactory image quality. For example, the imaging apparatus 100 may be applied to a variety of applications such as car electronics, drones, smart electronic products, tablet computers, wearable devices, medical devices, precision instruments, surveillance cameras, portable video recorders, identification systems, multi-lens devices, somatosensory detections, virtual reality, motion devices, home intelligent auxiliary systems and other electronic devices.

### 11th Embodiment

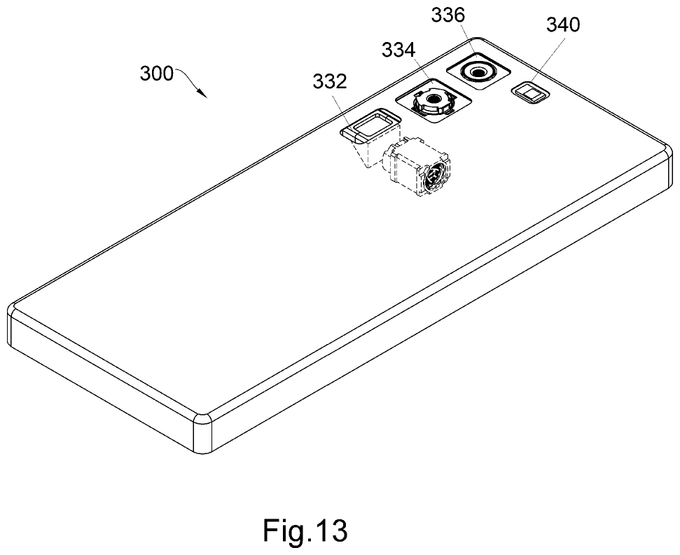

Please refer to FIG. 13. FIG. 13 is a rear view of an electronic device 300 according to the 11th embodiment. As shown in FIG. 13, the electronic device 300 includes a flash module 340, an imaging apparatus 332, an imaging apparatus 334, and an imaging apparatus 336 on the back side of the electronic device 300. The imaging apparatus 332, the imaging apparatus 334, and the imaging apparatus 336 face the same direction, and are vertically arranged on the back side of the electronic device 300. The flash module 340 is disposed on the upper edge of the back side of the electronic device 300, at the proximity of the imaging apparatus 336. The imaging apparatus 336 is an ultra-wide angle configuration, the imaging apparatus 334 is a wide-angle configuration utilizing the photographing lens assembly of the present disclosure, and the imaging apparatus 332 is a telephoto configuration. The field of view of the imaging apparatus 336 is larger than that of the imaging apparatus 334 by at least 20 degrees, and the field of view of the imaging apparatus 334 is larger than that of the imaging apparatus 332 by at least 20 degrees, so that for the imaging apparatuses disposed on the back side of the electronic device 300, the largest field of view with the imaging apparatus 336 is larger than the smallest field of view with the imaging apparatus 332 by at least 40 degrees.

### 12th Embodiment

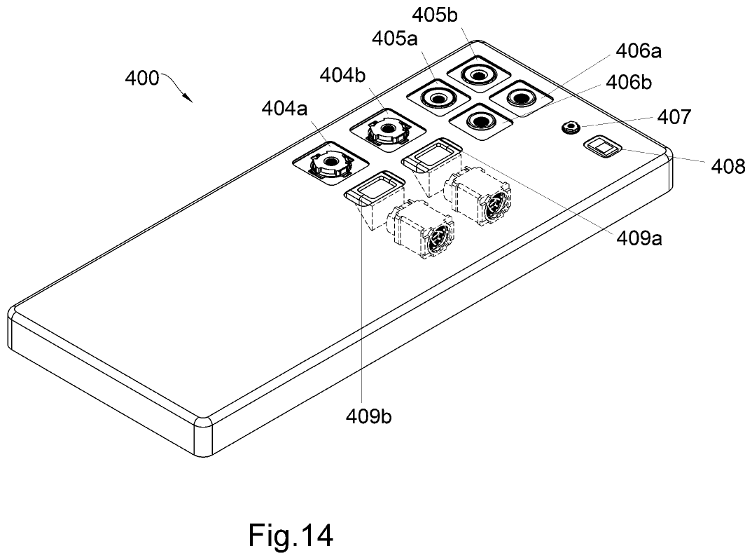

Please refer to FIG. 14. FIG. 14 is a rear view of an electronic device 400 according to the 12th embodiment. As shown in FIG. 14, the electronic device 400 includes a TOF (Time of Flight) module 407, a flash module 408, an imaging apparatus 404a, an imaging apparatus 404b, an imaging apparatus 405a, an imaging apparatus 405b, an imaging apparatus 406a, an imaging apparatus 406b, an imaging apparatus 409a, and an imaging apparatus 409b on the back side of the electronic device 400. The imaging apparatus 404a, the imaging apparatus 404b, the imaging apparatus 405a, the imaging apparatus 405b, the imaging apparatus 406a, the imaging apparatus 406b, the imaging apparatus 409a, and the imaging apparatus 409b face the same direction, and are divided into two rows vertically arranged on the back side of the electronic device 400. The TOF (Time of Flight) module 407 and the flash module 408 are disposed on the upper edge of the back side of the electronic device 400, at the proximity of the imaging apparatus 406a. The imaging apparatuses 405a and 405b are ultra-wide angle configurations. The imaging apparatuses 404a and 404b are wide-angle configurations utilizing the photographing lens assembly of the present disclosure. The imaging apparatuses 406a and 406b are telephoto configurations. The imaging apparatuses 409a and 409b are telephoto configurations with folded optical paths. The fields of view of the imaging apparatuses 405a, 405b are larger than those of the imaging apparatuses 404a, 404b by at least 30 degrees. The fields of view of the imaging apparatuses 404a, 404b are larger than those of the imaging apparatuses 406a, 406b, 409a, and 409b by at least 30 degrees.

### 13th Embodiment

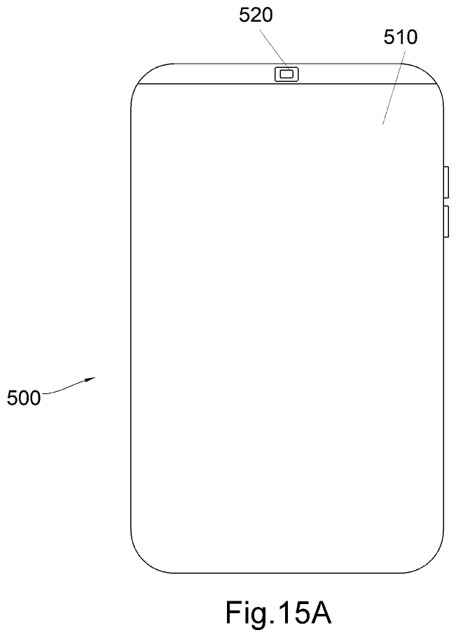

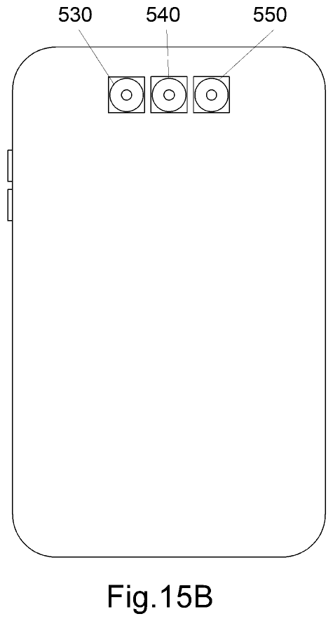

Please refer to FIG. 15A and FIG. 15B. FIG. 15A is a front view of an electronic device 500 according to the 13th embodiment. FIG. 15B is a rear view of the electronic device 500 shown in FIG. 15A. In the present embodiment, the electronic device 500 is a smartphone.

As shown in FIG. 15A, the front of the electronic device 500 includes a display 510 and an imaging apparatus 520, wherein the imaging apparatus 520 utilizes the photographing lens assembly of the present disclosure. As shown in FIG. 15B, the back of the electronic device 500 includes a telephoto configuration 530, a wide-angle configuration 540, and an ultra-wide configuration 550.

The aforementioned electronic devices are merely exemplary of practical use of the present disclosure and do not limit the scope of application of the imaging apparatus of the present disclosure. Preferably, an electronic device of the present disclosure can further include a control unit, a display unit, a storage unit, a random access memory unit (RAM) or a combination thereof.

The foregoing description, for purpose of explanation, has been described with reference to specific embodiments. It is to be noted that TABLES 1A-9B show different data of the different embodiments; however, the data of the different embodiments are obtained from experiments. The embodiments were chosen and described in order to best explain the principles of the disclosure and its practical applications, and thereby to enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photographing lens assembly comprising four lens elements, the four lens elements being, in order from an object side to an image side along an optical path: a first lens element, a second lens element, a third lens element and a fourth lens element, each of the first through fourth lens elements having an object-side surface facing the object side and an image-side surface facing the image side;
wherein the first lens element has negative refractive power, the image-side surface of the first lens element is concave in a paraxial region thereof, the image-side surface of the third lens element is convex in a paraxial region thereof, the image-side surface of the fourth lens element is concave in a paraxial region thereof, and the fourth lens element has at least one inflection point;
wherein an axial distance between the object-side surface of the first lens element and the image-side surface of the fourth lens element is TD, an axial distance between the image-side surface of the fourth lens elements and an image surface at d-line reference wavelength is BLd, an Abbe number of the fourth lens element at d-line reference wavelength is V4d, a focal length of the first lens element at d-line reference wavelength is f1d, a curvature radius of the image-side surface of the first lens element is R2, a curvature radius of the image-side surface of the second lens element is R4, a central thickness of the first lens element along the optical path is CT1, a central thickness of the third lens element along the optical path is CT3, a central thickness of the fourth lens element along the optical path is CT4, and the following conditions are satisfied:
$$1. < TD / BLd < 2.4 ;$$
$$10. < V 4 d < 24. ;$$
$$- 2.6 < f 1 d / R 2 < 0 ;$$
$$0.3 < \vert f 1 d / R 4 \vert < 5.4 ;$$
$$and$$
$$0.82 < ( CT 1 + CT 4 ) / CT 3 < 2.0 .$$

2. The photographing lens assembly of claim 1, wherein the object-side surface of the third lens element is concave in a paraxial region thereof, an f-number of the photographing lens assembly is Fno, and the following conditions are satisfied:
$$1.8 < Fno < 2.8 .$$

3. The photographing lens assembly of claim 1, wherein the image-side surface of the second lens element is convex in a paraxial region thereof, and the object-side surface of the fourth lens element has at least one inflection point.

4. The photographing lens assembly of claim 1, wherein a focal length of the photographing lens assembly at d-line reference wavelength is fd, an axial distance between the object-side surface of the first lens element and the image surface at d-line reference wavelength is TLd, and the following condition is satisfied:
$$0.25 < fd / TLd < 0.50 .$$

5. The photographing lens assembly of claim 1, wherein a focal length of the photographing lens assembly at d-line reference wavelength is fd, a sum of axial distances between every two adjacent lens elements of the photographing lens assembly is ΣAT, and the following condition is satisfied:
$$1. 6 < fd / \sum AT < 4. .$$

6. The photographing lens assembly of claim 1, wherein a focal length of the photographing lens assembly at d-line reference wavelength is fd, the central thickness of the fourth lens element along the optical path is CT4, and the following condition is satisfied:
$$1. 0 < fd / CT 4 < 4.0 .$$

7. The photographing lens assembly of claim 1, wherein the focal length of the first lens element at d-line reference wavelength is f1d, a focal length of the second lens element at d-line reference wavelength is f2d, and the following condition is satisfied:
$$- 3 \text{.0} < f 1 d / f 2 d < - 0.08 .$$

8. The photographing lens assembly of claim 1, wherein an axial distance between the first lens element and the second lens element is T12, the central thickness of the fourth lens element along the optical path is CT4, and the following condition is satisfied:
$$0.2 < T 12 / CT 4 < 1.5 .$$

9. The photographing lens assembly of claim 1, wherein a maximum effective radius on the image-side surface of the fourth lens element is Y4R2, the central thickness of the fourth lens element along the optical path is CT4, and the following condition is satisfied:
$$0.5 < Y 4 R 2 / CT 4 < 2.0 .$$

10. The photographing lens assembly of claim 1, wherein a displacement in parallel with the optical axis from an axial vertex on the image-side surface of the first lens element to a boundary of an optically effective area of the image-side surface of the first lens element is SAG1R2, the central thickness of the first lens element along the optical path is CT1, and the following condition is satisfied:
$$0 \text{.2} < \vert SAG 1 R 2 \vert / C T 1 < 1.2 .$$

11. The photographing lens assembly of claim 1, wherein a displacement in parallel with the optical axis from an axial vertex on the object-side surface of the first lens element to a boundary of an optically effective area of the object-side surface of the first lens element is SAG1R1, a maximum effective radius on the object-side surface of the first lens element is Y1R1, and the following condition is satisfied:
$$0.05 < \vert SAG 1 R 1 \vert / Y 1 R 1 < 0.2 .$$

12. An imaging apparatus, comprising the photographing lens assembly of claim 1 and an image sensor.

13. The imaging apparatus of claim 12, wherein the photographing lens assembly is used for light in a wavelength range of 700-1000 nm.

14. An electronic device, comprising the imaging apparatus of claim 12.

15. A photographing lens assembly comprising four lens elements, the four lens elements being, in order from an object side to an image side along an optical path: a first lens element, a second lens element, a third lens element and a fourth lens element, each of the first through fourth lens elements having an object-side surface facing the object side and an image-side surface facing the image side;
wherein the photographing lens assembly further comprises an aperture stop, the first lens element has negative refractive power, the image-side surface of the fourth lens element is concave in a paraxial region thereof, an axial distance between the object-side surface of the first lens element and the image-side surface of the fourth lens element is TD, an axial distance between the image-side surface of the fourth lens elements and an image surface at d-line reference wavelength is BLd, an Abbe number of the fourth lens element at d-line reference wavelength is V4d, an f-number of the photographing lens assembly is Fno, a sum of central thicknesses of the first lens element, the second lens element, the third lens element, and the fourth lens element along the optical path is ΣCT, a sum of axial distances between every two adjacent lens elements of the photographing lens assembly is ΣAT, a curvature radius of the object-side surface of the first lens element is R1, a curvature radius of the image-side surface of the first lens element is R2, an axial distance between the object-side surface of the first lens element and the image surface at d-line reference wavelength is TLd, an axial distance between the aperture stop and the image-side surface of the fourth lens element is SD, and the following conditions are satisfied:
$$1. < TD / BLd < 2.4 ;$$
$$10. < V 4 d < 24. ;$$
$$1.5 < Fno < 3. ;$$
$$2.8 < \sum C T / \sum A T < 5.5 ;$$
$$- 1.5 < ( R 1 + R 2 ) / ( R 1 - R 2 ) < 1.4 ; and$$
$$2.55 < TLd / SD < 4.5 .$$

16. The photographing lens assembly of claim 15, wherein the image-side surface of the first lens element is concave in a paraxial region thereof, the first through fourth lens elements have at least one inflection point, a field of view of the photographing lens assembly at d-line reference wavelength is FOVd, and the following condition is satisfied:
$$70 \text{.0} < F o V d < 110. .$$

17. The photographing lens assembly of claim 15, wherein both of the object-side surface and the image-side surface of the first lens element are aspheric, the sum of the central thicknesses of the first lens element, the second lens element, the third lens element, and the fourth lens element along the optical path is ΣCT, the sum of the axial distances between every two adjacent lens elements of the photographing lens assembly is CAT, and the following condition is satisfied:
$$3 \text{.0} < \sum C T / \sum A T < 4.8 .$$

18. The photographing lens assembly of claim 15, wherein a curvature radius of the image-side surface of the third lens element is R6, a curvature radius of the image-side surface of the fourth lens element is R8, and the following condition is satisfied:
$$- 15.0 < ( R 6 - R 8 ) / ( R 6 + R 8 ) < 5. .$$

19. The photographing lens assembly of claim 15, wherein a central thickness of the first lens element along the optical path is CT1, a central thickness of the third lens element along the optical path is CT3, and the following condition is satisfied:
$$0.4 < C T 1 / C T 3 < 0.7 .$$

20. The photographing lens assembly of claim 15, wherein an Abbe number of the second lens element at d-line reference wavelength is V2d, the Abbe number of the fourth lens element at d-line reference wavelength is V4d, and the following condition is satisfied:
$$0.5 < V 2 d / V 4 d < 1.5 .$$

21. The photographing lens assembly of claim 15, wherein an axial distance between the first lens element and the second lens element is T12, an axial distance between the second lens element and the third lens element is T23, an the axial distance between the third lens element and the fourth lens element is T34, and the following condition is satisfied:
$$0.01 < T 23 / ( T 12 + T 34 ) < 0.45 .$$

22. The photographing lens assembly of claim 15, wherein a focal length of the second lens element at d-line reference wavelength is f2d, a focal length of the fourth lens element at d-line reference wavelength is f4d, and the following condition is satisfied:
$$\vert f 2 d / f 4 d \vert < 1.25 .$$

23. A photographing lens assembly comprising four lens elements, the four lens elements being, in order from an object side to an image side along an optical path: a first lens element, a second lens element, a third lens element and a fourth lens element, each of the first through fourth lens elements having an object-side surface facing the object side and an image-side surface facing the image side;
wherein the first lens element has negative refractive power, the image-side surface of the first lens element is concave in a paraxial region thereof, the second lens element has positive refractive power, the image-side surface of the fourth lens element is concave in a paraxial region thereof, and the fourth lens element has at least one inflection point;
wherein an axial distance between the object-side surface of the first lens element and the image-side surface of the fourth lens element is TD, an axial distance between the image-side surface of the fourth lens elements and an image surface at d-line reference wavelength is BLd, an Abbe number of the fourth lens element at d-line reference wavelength is V4d, a focal length of the first lens element at d-line reference wavelength is f1d, a curvature radius of the image-side surface of the first lens element is R2, an axial distance between the first lens element and the second lens element is T12, a central thickness of the first lens element along the optical path is CT1, a curvature radius of the object-side surface of the second lens element is R3, a curvature radius of the image-side surface of the second lens element is R4, and the following conditions are satisfied:
$$1. < TD / BLd < 2.4 ;$$
$$10. < V4 d < 24. ;$$
$$- 2.8 < f 1 d / R 2 < - 0.1 ;$$
$$0.2 < T 12 / C T 1 < 1.7 ; and$$
$$- 0.48 < ( R 3 - R 4 ) / ( R 3 + R 4 ) < 1.6 .$$

24. The photographing lens assembly of claim 23, wherein the curvature radius of the object-side surface of the second lens element is R3, the curvature radius of the image-side surface of the second lens element is R4, and the following condition is satisfied:
$$0.10 < ( R 3 - R 4 ) / ( R 3 + R 4 ) < 1.4 .$$

25. The photographing lens assembly of claim 23, wherein an axial distance between the object-side surface of the first lens element and the image surface at d-line reference wavelength is TLd, an entrance pupil diameter of the photographing lens assembly at d-line reference wavelength is EPDd, and the following condition is satisfied:
$$5.0 < TLd / E P D d < 9. .$$

26. The photographing lens assembly of claim 23, further comprising an aperture stop disposed between the second lens element and the third lens element, wherein the axial distance between the image-side surface of the fourth lens elements and an image surface at d-line reference wavelength is BLd, an axial distance between the aperture stop and the image-side surface of the fourth lens element is SD, and the following condition is satisfied:
$$0.7 < BLd / SD < 2.0 .$$

27. The photographing lens assembly of claim 23, wherein the axial distance between the first lens element and the second lens element is T12, an axial distance between the second lens element and the third lens element is T23, an axial distance between the third lens element and the fourth lens element is T34, and the following condition is satisfied:
$$1.6 < T 12 / ( T 23 + T 34 ) < 5. .$$

28. The photographing lens assembly of claim 23, wherein an Abbe number of a lens element at d-line reference wavelength is Vd, and at least two lens elements among the first through fourth lens elements of the photographing lens assembly satisfy the following condition:
Vd<22.0.
